(19) United States
(12) Patent Application Publication
(10) Pub. No.: US 2010/0075045 A1
(43) Pub. Date: Mar. 25, 2010

(54) INKJET RECORDING MEDIUM AND INKJET RECORDING METHOD

(75) Inventors: Hideki KAIMOTO, Shizuoka-ken (JP); Wataru ONO, Shizuoka-ken (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/559,538

(22) Filed: Sep. 15, 2009

(30) Foreign Application Priority Data
Sep. 25, 2008 (JP) 2008-245476

(51) Int. Cl. B41M 5/50; B05D 5/00

(52) U.S. Cl. 427/256; 428/32.25

(57) ABSTRACT

The invention provides an inkjet recording medium including at least two ink receiving layers containing inorganic fine particles and a water soluble resin on a non-water-absorptive support, wherein a mass ratio of the inorganic fine particles to the water soluble resin in an upper layer of the ink receiving layers which is the furthest away from the non-water-absorptive support is larger by 1 or more than that in a lower layer of the ink receiving layers which is located between the upper layer and the non-water-absorptive support, which is capable of forming an image with a high color density and small changes in hue; and an inkjet recording method of forming a clear and high-density recorded image with suppressed changes in hue from the hue immediately after printing.

### CROSS-REFERENCE TO RELATED APPLICATION

This application claims priority under 35 USC 119 from Japanese Patent Application No. 2008-245476 filed on Sep. 25, 2008, the disclosure of which is incorporated by reference herein.

### BACKGROUND OF THE INVENTION

1. Field of the Invention

The present invention relates to an inkjet recording medium and an inkjet recording method.

2. Related Art

With recent rapid development of the information technology industry, various information processing systems are being developed, and recording methods and recording devices suitable for each information processing system are also being put to practical use. Among these, an inkjet recording method has been increasingly widely used because the inkjet recording method has advantages in that the method allows recording on various recording materials, hardware (apparatus) is relatively inexpensive and compact, the method is excellent in quietness, and the like. Also, in recording utilizing the inkjet recording method, a so-called photo-like high-definition recorded article can be obtained.

A recording medium for inkjet recording is generally required to have properties, such as (1) quick-drying properties (high ink absorption rate), (2) proper and uniform dot diameter (no blur), (3) excellent granularity, (4) high dot circularity, (5) high color density, (6) high color saturation (no dullness), (7) excellent water resistance, lightfastness, and ozone resistance of an image area, (8) high whiteness degree, (9) high storage stability (no yellowing or image blur after prolonged storage), (10) resistance to deformation and excellent dimensional stability (low curling), and (11) excellent traveling properties in hardware.

In view of the above, a recording medium having an ink receiving layer having a porous structure has been put to practical use in recent years. According to the recording medium, excellent quick-drying properties and high glossiness are obtained. Moreover, an inkjet recording medium capable of providing a clear and high quality image and having excellent storage properties has been desired.

As an image printing method for obtaining a high density image, an inkjet recording method including performing heat treatment after image printing has been disclosed (e.g., Japanese Patent Application Laid-Open (JP-A) No. 2006-240298).

As another method for obtaining a high density image, inkjet ink has been variously examined, and an increase in printed image density depending on the content and type of water soluble organic solvents contained in ink has been disclosed (e.g., JP-A No. 2005-336489).

In order to provide an inkjet recording medium excellent in image fastness with respect to traces of gas (particularly, ozone) present in the air without impairing the absorbability of a high-grade ink without image gloss unevenness and the strength of the coated film in inkjet recording using an aqueous pigment ink, an inkjet recording medium which has a two-layer structure containing amorphous silica and polyvinyl alcohol as a binder on a base material and in which the P/B ratio of the amorphous silica and the binder in an upper layer is smaller than the P/B ratio of a lower layer is disclosed (for example, refer to Japanese Patent Application Laid-Open (JP-A) No. 2005-169666).

### SUMMARY

According to an aspect of the invention, there is provided an inkjet recording medium including at least two ink receiving layers containing inorganic fine particles and a water soluble resin on a non-water-absorptive support, wherein a mass ratio of the inorganic fine particles to the water soluble resin in an upper layer of the ink receiving layers which is the furthest away from the non-water-absorptive support is larger by 1 or more than that in a lower layer of the ink receiving layers which is located between the upper layer and the non-water-absorptive support, which is capable of forming an image with a high color density and small changes in hue; and an inkjet recording method of forming a clear and high-density recorded image with suppressed changes in hue from the hue immediately after printing.

### DETAILED DESCRIPTION

However, the need for image quality has been recently increased more and more, and a higher level of image quality is required.

In addition to image quality and storability, there is a problem inherent to the inkjet recording method. That is, changes in hue occur with time from the hue obtained immediately after printing, and it takes a long time before the image is stabilized. Particularly, in a case where drying of the recorded image is not sufficient, when an object such as another recording material is superimposed on a part of the recorded image, there may be a difference in hue between the superimposed portion and the non-superimposed portion (namely, an overlap trace may be caused).

The present invention has been made in view of the above circumstances, and aims to provide an inkjet recording medium on which it is possible to form an image with higher color density and suppressed changes in hue, and an inkjet recording method that can provide a clear and high density recorded image and can suppress changes in hue from the hue obtained immediately after image printing.

The present inventors have conducted extensive researches on the above-described problems, and, as a result, have found, by recording (image printing) using inkjet ink containing a specific amount of specific water soluble organic solvent, not only that a clear and high density recorded image can be obtained but also that the changes in hue from the hue obtained immediately after image printing can be remarkably improved. Moreover, it has been found that, by drying, as post treatment, the recording medium after image printing, the density of the recorded image can be further increased and the changes in hue can be further suppressed.

More specifically, the inventors found, after studying hard the problems, that the objects to solve the problems may be achieved by the following items <1> to <10>. The present invention may namely provide the following items <1> to <10>:

<1> An inkjet recording medium including: at least two ink receiving layers which contain inorganic fine particles and a water soluble resin on a non-water-absorptive support, wherein a mass ratio of the inorganic fine particles to the water soluble resin in an upper layer of the ink receiving layers which is the furthest away from the non-water-absorptive support is larger by 1 or more than a mass ratio of the inorganic fine particles to the water soluble resin in a lower layer of the ink receiving layers which is located between the upper layer and the non-water-absorptive support.

<2> The inkjet recording medium according to item <1>, wherein the inorganic fine particles are vapor-phase process silica.

<3> The inkjet recording medium according to item <1> or item <2>, wherein the water soluble resin is a polyvinyl alcohol.

<4> The inkjet recording medium according to any one of items <1> to <3>, wherein the content of the water soluble resin is 9% by mass to 40% by mass with respect to the total solid mass of the ink receiving layer.

<5> The inkjet recording medium according to any one of items <1> to <4>, wherein an average primary particle diameter of the inorganic fine particles is 20 nm or less, and an average secondary particle diameter of the inorganic fine particles is 200 nm or less.

<6> The inkjet recording medium according to any one of items <1> to <5>, wherein the mass ratio of the inorganic fine particles to the water soluble resin in the upper layer of the ink receiving layers is from 3 to 25, and the mass ratio of the inorganic fine particles to the water soluble resin in the lower layer is from 1.5 to 6.

<7> The inkjet recording medium according to any one of items <1> to <6>, wherein the ink receiving layers further include a boron compound and a zirconyl compound.

<8> An inkjet recording method including performing recording on the inkjet recording medium according to any one of items <1> to <7> by using an inkjet ink including at least a dye, water and a water soluble organic solvent, wherein 40% by mass or more of the water soluble organic solvent is at least one selected from the group consisting of ethylene glycol monoalkyl ether, diethylene glycol monoalkyl ether, propylene glycol monoalkyl ether, dipropylene glycol monoalkyl ether, alkanediol, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

<9> The inkjet recording method according to item <8>, further including drying the inkjet recording medium after the recording.

<10> The inkjet recording method according to item <9>, wherein the drying is performed at 50° C. to 200° C. for 1 second to 5 minutes.

<Inkjet Recording Medium>

The inkjet recording medium according to the present invention includes at least two ink receiving layers which contain inorganic fine particles and a water soluble resin on a non-water-absorptive support wherein a mass ratio of the inorganic fine particles to the water soluble resin in an upper layer of the ink receiving layers which is the furthest away from the non-water-absorptive support is larger by 1 or more than a mass ratio of the inorganic fine particles to the water soluble resin in a lower layer of the ink receiving layers which is located between the upper layer and the non-water-absorptive support.

The inkjet recording medium according to the present invention may further contain other components and may have other layers, if necessary.

[Ink Receiving Layer]

The inkjet recording medium of the present invention includes at least two ink receiving layers. The ink receiving layers are provided on a non-water-absorptive support. In the at last two ink receiving layers in the present invention, each of the layers contains inorganic fine particles and a water soluble resin.

In the present invention, the ink receiving layer which is the furthest away from the non-water-absorptive support is referred to as the “upper layer”, and the ink receiving layer which is located between the upper layer and the non-water-absorptive support is referred to as the “lower layer”. Three or more ink receiving layers may be included in the inkjet recording medium of the present invention. In this case, the “lower layer” will include two or more layers.

The inkjet recording medium in which two ink receiving layers are provided on the non-water-absorptive support will be mainly described herein.

Hereinafter, the inorganic fine particles and water soluble resin contained in the ink receiving layer as well as other components which are contained if necessary will be described.

(Water Soluble Resin)

The ink receiving layer of the invention includes at least one water soluble resin.

In the invention, the “water soluble resin” refers to a resin that finally dissolves in 100 g of water at 20° C. in an amount of 0.05 g or more and preferably 0.1 g or more through a heating or cooling process.

Examples of the water soluble resin include polyvinyl alcohol-based resins having a hydroxy group as a hydrophilic structural unit [polyvinyl alcohol (PVA), acetoacetyl modified polyvinyl alcohol, cation modified polyvinyl alcohol, anion modified polyvinyl alcohol, silanol modified polyvinyl alcohol, polyvinyl acetal, etc.], cellulose based resins [methyl cellulose (MC), ethyl cellulose (EC), hydroxyethyl cellulose (HEC), carboxymethyl cellulose (CMC), hydroxypropyl cellulose (HPC), hydroxyethyl methyl cellulose, hydroxypropyl methyl cellulose, etc.], chitins, chitosans, starch, or resins having an ether bond [polyethylene oxide (PEO), polypropylene oxide (PPO), polyethylene glycol (PEG), polyvinyl ether (PVE), etc.,], and resins having a carbamoyl group [polyacrylamide (PAAM), polyvinyl pyrrolidone (PVP), polyacrylic acid hydrazide, etc.]. Examples of the water soluble resin further include polyacrylate, maleic acid resin, alginic acid salts, and gelatins each having a carboxy group as a dissociative group.

Among the above, the polyvinyl alcohol-based resin which is a nonionic polymer is preferable and polyvinyl alcohol is particularly preferable.

In order to prevent reduction in film strength or cracking at the time when the layer is dried, due to too small a content of the water soluble resin, and prevent reduction in ink absorptivity caused by blocking of voids by resin due to too high a content of resin, the content of the water soluble resin in the ink receiving layer is preferably 9% by mass to 40% by mass, more preferably 12% by mass to 33% by mass with respect to the total solid mass in ink receiving layer.

These water soluble resins and the inorganic fine particles described below, which constitute mainly the ink receiving layer, each may be a single-component substance or a combination of multiple components.

From the viewpoint of preventing cracking, the number average polymerization degree of the polyvinyl alcohol-based resin is preferably 1800 or more, and more preferably 2000 or more. From the viewpoint of transparency of the layer, when a water soluble resin is used in combination with silica particles, the kind of water soluble resin is important. Particularly, when anhydrous silica is used, polyvinyl alcohol-based resins are preferable as the water soluble resin. Among them, polyvinyl alcohol-based resins having a saponification degree of 70% to 99% are preferable.

As the polyvinyl alcohol-based resins, derivatives of the specific example are also included, and the polyvinyl alcohol-based resins may be used singularly or in a combination of two or more of them.

The polyvinyl alcohol-based resin has a hydroxy group in the structural unit thereof. The hydroxy group and a silanol group on the surface of silica fine particles form a hydrogen bond to thereby facilitate the formation of a three-dimensional network structure having secondary particles of the silica fine particles as a chain unit. It is thought that, by the formation of such a three-dimensional network structure, an ink receiving layer of a porous structure having a high porosity can be formed.

In the inkjet recording medium, the porous ink receiving layer thus obtained rapidly absorbs ink due to a capillary phenomenon, thereby forming favorable dots having a high circularity and having no ink blur.

(Inorganic Fine Particles)

The ink receiving layer according to the present invention contains at least one type of inorganic fine particles. Examples of the inorganic fine particles include silica fine particles, colloidal silica, titanium dioxide, barium sulfate, calcium silicate, zeolite, kaolinite, halloysite, mica, talc, calcium carbonate, magnesium carbonate, calcium sulfate, alumina fine particles, boehmite, and pseudoboehmite. Among these particles, silica fine particles, colloidal silica, alumina fine particles, and pseudoboehmite are preferable. Particularly, vapor-phase process silica fine particles are preferable.

The silica fine particles described above have an extremely high specific surface area, accordingly it provides an ink receiving layer with a higher ink absorptivity and retention efficiency. In addition, the silica fine particles have a low refractive index, and thus if dispersed to a suitable particle diameter, provides the ink receiving layer with better transparency, and higher color density and favorable coloring is obtainable. The transparency of ink receiving layer is important from the viewpoints of obtaining a high color density, favorable coloring, and favorable glossiness not only for applications wherein the transparency is required such as OHP sheets and the like, but also for applications as recording sheets such as photographic glossy papers and the like.

The average primary particle diameter of the inorganic fine particles is preferably 20 nm or less, more preferably 15 nm or less, and particularly preferably 10 nm or less. In the case where the average primary particle diameter is 20 nm or less, the characteristics of ink absorption can be effectively improved and at the same time, the glossiness of the surface of the ink receiving layer can be enhanced.

The average secondary particle diameter of the inorganic fine particles is preferably 800 nm or less, more preferably 200 nm or less, and particularly preferably 150 nm or less. In the case where the average secondary particle diameter is 800 nm or less, a photo-like high-quality recorded article can be obtained.

In particular with silica fine particles, since the surface has silanol groups, the particles easily adhere to each other through hydrogen bond of the silanol groups, and there is an adhesion effect between the particles through the silanol groups and the water soluble resin. Hence, when the average primary particle diameter is 20 nm or less, the porosity of the ink receiving layer is high, and a structure with high transparency can be formed, and the characteristics of ink absorption can be effectively raised.

Silica fine particles are commonly classified roughly into wet method particles and dry method (vapor-phase process) particles according to the method of manufacture. By the wet method, silica particles are mainly produced by generating an activated silica by acid decomposition of a silicate, polymerizing the activated silica to a proper degree, and coagulating and precipitating the resulting polymeric silica to give a hydrated silica. Alternatively by the vapor-phase process, an anhydrous silica is mainly produced by high-temperature vapor-phase hydrolysis of a silicon halide (flame hydrolysis process), or by reductively heating and vaporizing quartz sand and coke in an electric furnace by applying an arc discharge and then oxidizing the vaporized silica with air (arc method).

The vapor-phase process silica (anhydrous silica fine particles produced by vapor-phase process) is different in the density of silanol groups on the surface and the presence of voids therein and exhibits properties different from hydrated silica. The vapor-phase process silica is suitable for forming a three-dimensional structure having a higher porosity. The reason is not clearly understood. Hydrated silica fine particles have a higher density of silanol groups of 5 silanol groups/nm² to 8 silanol groups/nm² on their surface. Thus the silica fine particles tend to coagulate densely. While the vapor-phase process silica fine particles have a lower density of silanol groups of 2 silanol groups/nm² to 3 silanol groups/nm² on their surface. Therefore, vapor-phase process silica seems to cause more scarce, softer coagulations (flocculates), consequently leading to a structure having a higher porosity.

In the present invention, it is preferable that all the inorganic fine particles are vapor-phase process silica fine particles (anhydrous silica) obtained by the above wet method, and it is more preferable that the silica fine particles have a density of silanol groups of 2 silanol groups/nm² to 3 silanol groups/nm² on their surface.

<<Content Ratio (PB ratio) of Inorganic fine Particles to Water Soluble Resin>>

Concerning the at last two ink receiving layers in the present invention, it is necessary that a ratio (mass ratio) of the inorganic fine particles to the water soluble resin in an upper layer of the ink receiving layers which is the furthest away from the non-water-absorptive support is larger by 1 or more than a mass ratio of the inorganic fine particles to the water soluble resin in a lower layer of the ink receiving layers which is located between the upper layer and the non-water-absorptive support.

The mass ratio of the inorganic fine particles to the water soluble resin is a ratio of a content of the inorganic fine particles (preferably silica particles) to a content of the water soluble resin in the ink receiving layer. The ratio is represented by “x/y”, when the total mass of the inorganic fine particles in the ink receiving layer is designated as x and the total mass of the water soluble resin in the ink receiving layer is designated as y, and it is also referred to as the PB ratio. The PB ratio has a big effect on a film structure of the ink receiving layer. That is, when the PB ratio is increased, the porosity, pore volume, and surface area (per unit mass) are increased.

The above-described relationship of the PB ratio of the upper layer of the ink receiving layers and the PB ratio of the lower layer of the ink receiving layers allows for achieving inkjet recording with a high color density. Further, the color density is further improved by using an inkjet ink with a specific water soluble organic solvent as described hereinafter and the ink is excellent in depression effect of changes in the hue.

In this regard, a difference between the PB ratio of the upper layer of the ink receiving layers and the PB ratio of the lower layer of the ink receiving layers [(PB ratio of the upper layer)−(PB ratio of the lower layer)] is referred to as a “ΔPB ratio” herein.

The ΔPB ratio is preferably 1 to 25, more preferably 2 to 15, and even more preferably 3 to 10.

In a case of the ink receiving layer being a monolayer, when in an inkjet recording medium goes past a transportation system of an inkjet printer, in some cases, it receives stress; accordingly, the ink receiving layer necessarily has sufficient film strength. Furthermore, when the inkjet recording medium is cut in sheet, in order to inhibit the ink receiving layer from cracking and peeling as well, the ink receiving layer is necessary to have sufficient film strength. Thus, the PB ratio is preferably 4.5 or less from the viewpoint of increasing hardness of the ink receiving layer. Further the PB ratio is more preferably 4.3 or less, and even more preferably 4.15 or less. Though not particularly restricted, in order to prevent reduction in ink absorptivity caused by blocking of voids by resin, the PB ratio is preferably 1.5 or more. Furthermore, from the viewpoint of assuring high speed ink absorptivity, the PB ratio is preferably 2.0 or more.

However, in the case of the multilayer in the present invention, the ΔPB ratio is made to be in the range of 1 to 25 while the PB ratio of the whole ink receiving layer is kept within the above-described range. As a result, the film strength, ink absorptivity, color density, and suppression of changes in the hue can be improved to a high level.

From the above-described viewpoints, the PB ratio of the upper layer of the ink receiving layers is preferably 3 to 25, and more preferably 5 to 15.

Further, the PB ratio of the lower layer of the ink receiving layers is preferably 1.5 to 6, and more preferably 2.5 to 5.

For example, when a coating solution, containing anhydrous silica fine particles, having an average primary particle diameter of 20 nm or less, and a water soluble resin thoroughly dispersed in an aqueous solution at a PB ratio (x/y) of from 2 to 4.5, is applied on a support and dried, a three-dimensional network structure having secondary particles of silica fine particles as the network chains is formed. Such a coating solution easily provides a light-transmitting porous layer having an average pore diameter of 30 nm or less, a porosity of 50% to 80%, a pore specific volume of 0.5 mL/g or more, and a specific surface area of 100 m²/g or more.

(Crosslinking Agent)

The ink receiving layer according to the present invention contains at least one kind of crosslinking agents.

With respect to the ink receiving layer according to the invention, it is preferable that the layer containing a water soluble resin and the like contains additionally a crosslinking agent that allows crosslinking of the water soluble resin, and thus is a porous layer hardened by the crosslinking reaction between the crosslinking agent and the water soluble resin. By adding the crosslinking agent, the water soluble resin is crosslinked and, as a result, a highly hardened ink receiving layer can be obtained.

The above crosslinking agent may be selected appropriately in relation to the water soluble resin contained in the ink receiving layer, but boron compounds are preferable, as they allow faster crosslinking reaction. Examples of the boron compounds include borax; boric acid; borate salts such as orthoborate salts, InBO₃, ScBO₃, YBO₃, LaBO₃, Mg₃(BO₃)₂, and Co₃(BO₃)₂; diborate salts such as Mg₂B₂O₅, and Co₂B₂O₅; metaborate salts such as LiBO₂, Ca(BO₂)₂, NaBO₂, and KBO₂; tetraborate salts such as Na₂B₄O₇.10H₂O; pentaborate salts such as KB₅O₈.4H₂O, and CsB₅O₅; hexaborate salts such as Ca₂B₆O₁₁.7H₂O; and the like. Among them, borax, boric acid and borate salts are preferable since they are able to promptly cause a crosslinking reaction. Particularly, boric acid is preferable, and the combination of polyvinyl alcohol, that is a water soluble resin, and boric acid is most preferable.

The crosslinking agents for polyvinyl alcohol further include the following compounds other than the above boron compounds. Examples of such crosslinking agents include aldehyde compounds such as formaldehyde, glyoxal and glutaraldehyde; ketone compounds such as diacetyl and cyclopentanedione; active halogen compounds such as bis(2-chloroethylurea), 2-hydroxy-4,6-dichloro-1,3,5-triazine and 2,4-dichloro-6-hydroxy-s-triazine sodium salt; active vinyl compounds such as divinyl sulfonic acid, 1,3-bis(vinylsulfonyl)-2-propanol, N,N′-ethylenebis(vinylsulfonylacetamide) and 1,3,5-triacryloyl-hexahydro-s-triazine; N-methylol compounds such as dimethylolurea and methylol dimethylhydantoin; melamine resins such as methylol melamine and alkylated methylol melamine; epoxy resins;

isocyanate compounds such as 1,6-hexamethylenediisocyanate; aziridine compounds such as those described in U.S. Pat. Nos. 3,017,280 and 2,983,611; carboxyimide compounds such as those described in U.S. Pat. No. 3,100,704; epoxy compounds such as glycerol triglycidyl ether; ethyleneimino compounds such as 1,6-hexamethylene-N,N′-bisethylene urea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chromium alum, potassium alum, zirconyl acetate and chromium acetate; polyamine compounds such as tetraethylene pentamine; hydrazide compounds such as adipic acid dihydrazide; and low molecular compounds or polymers containing at least two oxazoline groups.

Furthermore, as the crosslinking agent of the water soluble resin in the invention, polyvalent metal compounds cited below are also preferable. The polyvalent metal compound not only works as the crosslinking agent but also further improves the ozone resistance, image blur resistance and glossiness.

As the polyvalent metal compound, water soluble compounds are preferable. Examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, copper (II) chloride, ammonium copper (II) chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminum sulfate, aluminum alum, aluminum sulfite, aluminum thiosulfate, polyaluminum chloride, aluminum nitrate nonahydrate, aluminum chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetyl acetonate, titanium lactate, zirconyl acetyl acetonate, zirconyl acetate, zirconyl sulfate, zirconyl ammonium carbonate, zirconyl stearate, zirconyl octylate, zirconyl nitrate, zirconyl oxychloride, zirconyl hydroxychloride, chromium acetate, chromium sulfate, magnesium sulfate, magnesium chloride hexahydrate, magnesium citrate nonahydrate, sodium phosphorustungstate, sodium tungsten citrate, 12 tungstophosphoric acid n-hydrate, 12 tungstosilicic acid 26-hydrate, molybdenum chloride, 12 molybdophosphoric acid n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride and bismuth nitrate.

Among the foregoing polyvalent metal compounds, preferable examples include aluminum-containing compounds (water soluble aluminum compounds) such as aluminum sulfate, aluminum alum, aluminum sulfite, aluminum thiosulfate, polyaluminum chloride, aluminum nitrate nonahydrate and aluminum chloride hexahydrate; zirconyl-containing compounds (water soluble zirconyl compounds) such as zirconyl acetyl acetonate, zirconyl acetate, zirconyl sulfate, zirconyl ammonium carbonate, zirconyl stearate, zirconyl octylate, zirconyl nitrate, zirconyl oxychloride and zirconyl hydroxychloride; and titanium-containing compounds such as titanium tetrachloride, tetraisopropyl titanate, titanium acetyl acetonate and titanium lactate. Among these, polyaluminum chloride, zirconyl acetate, zirconyl ammonium carbonate and zirconyl oxychloride are particularly preferable.

As the crosslinking agent in the invention, among above-cited compounds, boron compounds and zirconyl compounds are particularly preferable.

For example, when polyvinyl alcohol is used as a water soluble resin and boric acid is used as a crosslinking agent in the present invention, the content of the crosslinking agent is preferably 5% by mass to 50% by mass, more preferably 8% by mass to 30% by mass with respect to the water soluble resin in order to obtain sufficient effects of the present invention and inhibit the swelling of polyvinyl alcohol without causing cracks of the ink receiving layer and lack of scratch resistance.

The crosslinking agents may be used singularly or in a combination of two or more kinds. From the viewpoints of working as a preferable crosslinking agent and of further improving the ozone resistance, image blur resistance and glossiness, the polyvalent metal compound (particularly preferably, zirconyl compound) is contained, relative to the water soluble resin, preferably in an amount of 0.1% by mass or more, more preferably 0.5% by mass or more and particularly preferably 1.0% by mass or more. Furthermore, the upper limit of the content of the polyvalent metal compound, though not particularly restricted, from the viewpoints of image density, ink absorptivity and suppression of curl of the recording medium, is preferably 50% by mass.

(Ammonium Carbonate)

In the ink receiving layer according to the invention, ammonium carbonate is preferably further contained. When ammonium carbonate is contained in the ink receiving layer, an ink receiving layer high in the hardness can be obtained.

A content of the ammonium carbonate is, relative to the water soluble resin, preferably 8% by mass or more, more preferably 9% by mass or more and particularly preferably 11% by mass or more. Furthermore, the upper limit of the content thereof, though not particularly restricted, from the viewpoints of the image density, ink absorptivity and suppression of curl of the recording medium, is preferably 20% by mass.

(Water Dispersible Cationic Resin)

Furthermore, as a component of the ink receiving layer according to the invention, a water dispersible cationic resin may be contained. As the water dispersible cationic resin, a urethane resin that is a cation-modified self-emulsifiable polymer is preferable and the glass transition temperature thereof is preferably lower than 50° C.

The “cation-modified self-emulsifiable polymer” means a polymer that can naturally form stable emulsified dispersion in an aqueous dispersion medium without using an emulsifier or surfactant or with only a slight amount thereof added. Quantitatively, the “cation-modified self-emulsifiable polymer” represents a polymer material that has stable emulsion dispersibility at a concentration of 0.5% by mass or more relative to the aqueous dispersion medium at room temperature of 25° C. The concentration is preferably 1% by mass or more and more preferably 3% by mass or more.

As the “cation-modified self-emulsifiable polymer” according to the invention, more specifically, for instance, polyaddition or polycondensation polymer having a cationic group such as a primary, secondary or tertiary amino group or a quaternary ammonium group can be cited.

For the above polymers, vinyl polymerization based polymers can be used, such as polymers obtained by the polymerization of the following vinyl monomers. Examples include: acrylic acid esters and metacrylic acid esters (in which the ester group is a substituted or unsubstituted alkyl or aryl groups, for example, methyl, ethyl, n-propyl, isopropyl, n-butyl, sec-butyl, tert-butyl, hexyl, 2-ethylhexyl, tert-octyl, 2-chloroethyl, cyanoethyl, 2-acetoxyethyl, tetrahydrofurfuryl, 5-hydroxypentyl, cyclohexyl, benzyl, hydroxyethyl, 3-methoxybutyl, 2-(2-methoxyethoxy)ethyl, trifuroroethyl, 1H, 1H, 2H, 2H-perfluorodecyl, phenyl, trimethylphenyl, or 4-chlorophenyl);

vinyl esters, specifically aliphatic carboxylic acid vinyl esters which may have a substituent (for example, vinyl acetate, vinyl propionate, vinyl butyrate, vinyl isobutyrate, vinyl caproate, vinyl chloroacetate), aromatic carboxylic acid esters which may have a substituent (for example benzoic acid vinyl ester, 4-methyl benzoic acid vinyl ester, salicylic acid vinyl ester);

acrylamides, specifically acrylamide, N-monosubstituted acrylamides, and N-disubstituted acrylamides (for substituents, there are alkyl, aryl, and silyl proups which may have a substituent, for example, methyl, n-propyl, isopropyl, n-butyl, tert-butyl, tert-octyl, cyclohexyl, benzyl, hydroxymethyl, alkoxymethyl, phenyl, tetramethylphenyl, 4-chlorophenyl, and trimethylsilyl);

methacrylamides, specifically methacrylamide, N-monosubstituted methacrylamides, and N-disubstituted methacrylamides (for substituents, there are alkyl, aryl, and silyl groups which may have a substituent, for example, methyl, n-propyl, isopropyl, n-butyl, tert-butyl, tert-octyl, cyclohexyl, benzyl, hydroxymethyl, alkoxymethyl, phenyl, tetramethylphenyl, 4-chlorophenyl, and trimethylsilyl);

olefins (for example ethylene, propylene, 1-pentene, vinyl chloride, vinylidene chloride, isoprene, chloroprene, and butadiene), styrenes (for example, styrene, methylstyrene, isopropylstyrene, methoxystyrene, acetoxystyrene, and chlorostyrene), vinyl ethers (for example, methyl vinyl ether, butyl vinyl ether, hexyl vinyl ether, and methoxyethyl vinyl ether).

As the other vinyl monomer, examples include crotonate esters, itaconate esters, maleate diesters, fumarate diesters, methyl vinyl ketone, phenyl vinyl ketone, methoxyethyl vinyl ketone, N-vinyloxazolidone, N-vinylpyrrolidone, methylenemalonnitrile, diphenyl-2-acryloyloxyethyl phosphate, dipheyl-2-methacryloyloxyethyl phosphate, dibutyl-2-acryloyloxyethyl phosphate, dioctyl-2-methacryloyloxyethyl phosphate and the like.

As the above-mentioned monomer having a cationic group, there are, for example, monomers having a tertiary amino group, such as dialkylaminoethyl methacrylates, dialkylaminoethyl acrylates and the like.

As polyurethanes applicable to the cationic group-containing polymer, there are, for example, polyurethanes synthesized by addition polymerization reaction of various combinations of the diol compounds and the diisocyanate compound listed below.

Examples of the above-mentioned diol compound include ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,-hexanediol, 2-ethyl-1,3-hexanediol, 1,2-octanediol, 1,8-octanediol, 2,2,4-trimethyl-1,3-pentanediol, 1,4-cyclohexanedimethanol, hydroquinone, diethylene glycol, triethylene glycol, dipropylene glycol, tripropylene glycol, polyethylene glycols (average molecular weight=200, 300, 400, 600, 1000, 1500, 4000), polypropylene glycols (average molecular weight=200, 400, 1000), polyester polyols, 4,4′-dihydroxy-diphenyl-2,2-propane, 4,4′-dihydroxyphenylsulfone, and the like.

As for the above-mentioned diisocyanate compound, examples include methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenylene diisocyanate, p-phenylene diisocyanate, 3,3′-dimethyl-4,4′-diphenylmethane diisocyanate, 3,3′-dimethylbiphenylene diisocyanate, 4,4′-biphenylene diisocyanate, dicyclohexylmethane diisocyanate, methylene bis(4-cyclohexyl isocyanate), and the like.

As the cationic group contained in the cationic group-containing polyurethane, there are cationic groups such as primary, secondary and tertiary amines and quaternary ammonium salts. As the self-emulsifiable polymer used for the aqueous dispersion according to the invention, it is preferable to use a urethane resin having cationic groups such as tertiary amines or quaternary ammonium salts. The cationic group-containing polyurethanes can be obtained, for example, by introducing cationic groups into diols such as those described above at the time of synthesizing the polyurethane. Also, in the case of quaternary ammonium salts, polyurethanes containing tertiary amino groups may be quaternarized with a quaternarizing agent.

The diol compounds and diisocyanate compounds usable for synthesizing the polyurethane may be used each alone, or may be used in a combination of two or more in various proportions decided depending on the purpose (for example, control of the polymer glass transition temperature (Tg), improving solubility, providing compatibility with a binder, and improving stability of a dispersion).

(Mordant)

In the ink receiving layer according to the invention, preferably, with an intention of further improving the image blur resistance over time and water resistance, a mordant such as shown below is added. As the mordant, organic mordants such as cationic polymers (cationic mordants) and inorganic mordants such as water soluble metal compounds are preferable. As the cationic mordant, polymer mordants having, as a cationic functional group, a primary, secondary or tertiary amino group or a quaternary ammonium salt group can be preferably used. A cationic non-polymer mordant can be used as well.

As the polymer mordant, homopolymers of a monomer (a mordant monomer) having a primary, secondary or tertiary amino group and a salt thereof or a quaternary ammonium salt group, and copolymers or polycondensation products of the mordant monomer and other monomer (non-mordant monomer) can be preferably used. Furthermore, the polymer mordants can be used in either form of a water soluble polymer or latex particles dispersible in water.

Examples of the above mordant monomer include trimethyl-p-vinylbenzylammonium chloride, trimethyl-m-vinylbenzylammonium chloride, triethyl-p-vinylbenzylammonium triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride,

trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N-2-(4-vinylphenyl)ethylammonium acetate;

quaternary compounds obtained by reacting methyl chlorides, ethyl chlorides, methyl bromides, ethyl bromides, methyl iodides, or ethyl iodides with N,N-dimethylaminoethyl(meth)acrylate, N,N-diethylaminoethyl(meth)acrylate, N,N-dimethylaminopropyl(meth)acrylate, N,N-diethylaminopropyl(meth)acrylate, N,N-dimethylaminoethyl(meth)acrylamide, N,N-diethylaminoethyl(meth)acrylamide, N,N-dimethylaminopropyl(meth)acrylamide, or N,N-diethylaminopropyl(meth)acrylamide; and sulfonates, alkyl sulfonates, acetates, or alkyl carboxylates derived from the quaternary compounds by replacement of the anion.

Specific examples of such compounds include monomethyldiallylammonium chloride, trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, trimethyl-3-(acryloylamino)propylammonium chloride, triethyl-3-(acryloylamino)propylammonium chloride,

N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate, and trimethyl-3-(acryloylamino)propylammonium acetate.

Examples of other copolymerizable monomers include N-vinylimidazole and N-vinyl-2-methylimidazole. Further, by using a polymerization unit such as N-vinylacetamide, N-vinylformamide, then forming a vinylamine unit by hydrolysis after the polymerization, and a salt thereof also can be used.

The term “a non-mordant monomer” refers to a monomer that does not have a basic or cationic moiety, such as a primary, secondary or tertiary amino group, a salt thereof, or a quaternary ammonium base, and exhibits no or substantially little interaction with dye in inkjet ink.

Examples of non-mordant monomers include alkyl(meth)acrylates; cycloalkyl(meth)acrylates such as cyclohexyl(meth)acrylate; aryl(meth)acrylates such as phenyl(meth)acrylate; aralkyl ester such as benzyl(meth)acrylate; aromatic vinyl compounds such as styrene, vinyltoluene and α-methylstyrene; vinyl esters such as vinyl acetate, vinyl propionate and vinyl versatate; allyl esters such as allyl acetate; halogen-containing monomers such as vinylidene chloride and vinyl chloride; vinyl cyanides such as (meth)acrylonitrile; and olefins such as ethylene and propylene.

The above alkyl(meth)acrylates preferably have 1 to 18 carbon atoms in the alkyl moiety. Examples of such alkyl(meth)acrylates include methyl(meth)acrylate, ethyl(meth)acrylate, propyl(meth)acrylate, isopropyl(meth)acrylate, n-butyl(meth)acrylate, isobutyl(meth)acrylate, tert-butyl(meth)acrylate, hexyl(meth)acrylate, octyl(meth)acrylate, 2-ethylhexyl(meth)acrylate, lauryl(meth)acrylate, and stearyl(meth)acrylate.

Particularly preferred are methyl acrylate, ethyl acrylate, methyl methacrylate, ethyl methacrylate, and hydroxyethyl methacrylate.

One non-mordant monomer may be used alone or two or more kinds of non-mordant monomers may be used in combination.

Furthermore, as the polymer mordant, polydiallyldimethylammonium chloride, polymethacryloyloxyethyl-β-hydroxyethyldimethylammonium chloride, polyethyleneimine, polyamide-polyamine resins, cationic starch, dicyandiamide formaline condensates, dimethyl-2-hydroxypropylammonium salt polymers, polyamidine, polyvinylamine, dicyan-based cationic resins represented by dicyandiamide-formaline polycondensates, polyamine-based cationic resins represented by dicyanamide-diethylenetriamine polycondensates, epichlorohydrin-dimethylamine addition polymers, dimethyldiallylammonium chloride-SO₂ copolymers and diallylamine salt-SO₂ copolymers can be preferably cited.

Specific examples of the polymer mordant include those described in JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134 and 1-161236; U.S. Pat. Nos. 2,484,430, 2,548,564, 3,148,061, 3,309,690, 4,115,124, 4,124,386, 4,193,800, 4,273,853, 4,282,305, and 4,450,224; JP-A Nos. 1-161236, 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314.

As the inorganic mordant, other than the above, polyvalent water soluble metal salts and hydrophobic metal salt compounds can be cited. Specific examples of the inorganic mordants include salts and complexes of a metal selected from magnesium, aluminum, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten, and bismuth.

Specific examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, copper (II) chloride, ammonium copper (II) chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminum sulfate, aluminum alum, basic polyaluminum hydroxide, aluminum sulfite, aluminum thiosulfate, polyaluminum chloride, aluminum nitrate nonahydrate, aluminum chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconium acetylacetonate, zirconyl acetate, zirconyl sulfate, zirconyl ammonium carbonate, zirconyl stearate, zirconyl octanoate, zirconyl nitrate, zirconium oxychloride, zirconium hydroxychloride, chromium acetate, chromium sulfate, magnesium sulfate, magnesium chloride hexahydrate, magnesium citrate nonahydrate, sodium phosphotungstate, sodium tungsten citrate, dodecatungstophosphoric acid n-hydrate, dodecatungstosilicic acid 26-hydrate, molybdenum chloride, dodecamolybdophosphoric acid n-hydrate, potassium nitrate, manganese acetate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride and bismuth nitrate. Among these, aluminum-containing compounds, titanium-containing compounds, zirconium-containing compounds and compounds of metals belonging to IIIB group of periodic table (salts or complexes) are preferable.

Furthermore, the “polyvalent metal compounds” cited in the section of the (crosslinking agent) as well can be preferably used as the mordant.

An amount of the mordant added to the ink receiving layer is preferably in the range of 0.01 g/m² to 5 g/m².

(Other Components)

In addition, the ink receiving layer according to the invention is constructed to contain the following components if necessary.

To restrain the deterioration of the ink colorant, anti-fading agents such as various ultraviolet absorbers, antioxidants and singlet oxygen quenchers may be contained.

Examples of the ultraviolet absorbers include cinnamic acid derivatives, benzophenone derivative and benzotriazolyl phenol derivatives. Specific examples include (butyl α-cyanophenylcinnamate, o-benzotriazole phenol, o-benzotriazole-p-chlorophenol, o-benzotriazole-2,4-di-t-butylphenol, o-benzotriazole-2,4-di-t-octylphenol. A hindered phenol compound can be also used as an ultraviolet absorber, and phenols in which at least one of the second position and/or the sixth position is substituted by a branched alkyl group is preferable.

A benzotriazole based ultraviolet absorber, a salicylic acid based ultraviolet absorber, a cyano acrylate based ultraviolet absorber, and oxalic acid anilide based ultraviolet absorber or the like can be also used. For instance, the ultraviolet absorbers are described in JP-A Nos. 47-10537, 58-111942, 58-212844, 59-19945, 59-46646, 59-109055 and 63-53544, Japanese Patent Application Publication (JP-B) Nos. 36-10466, 42-26187, 48-30492, 48-31255, 48-41572 and 48-54965, 50-10726, U.S. Pat. Nos. 2,719,086, 3,707,375, 3,754,919 and 4,220,711 and the like.

A fluorescent whitening agent can be also used as an ultraviolet absorber, and specific examples include a coumalin based fluorescent whitening agent. Specific examples are described in JP-B Nos. 45-4699 and 54-5324 and the like.

Examples of the antioxidants are described in EP Nos. 223739, 309401, 309402, 310551, 310552 and 459416, D.E. Patent No. 3435443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, 63-113536,

63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437 and 5-170361, JP-B Nos. 48-43295 and 48-33212, and U.S. Pat. Nos. 4,814,262 and 4,980,275.

Specific examples of the antioxidants include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4,-tetrahydroquinoline, nickel cyclohexanoate, 2,2-bis(4-hydroxyphenyl)propane, 1,1-bis(4-hydroxyphenyl)-2-ethylhexane, 2-methy-4-methoxy-diphenylamine, 1-methyl-2-phenyl indole.

These anti-fading agents can be used singly or in combinations of two or more. The anti-fading agents can be dissolved in water, dispersed, emulsified, or they can be included within microcapsules. The amount of the anti-fading agents added is preferably 0.01% by mass to 10% by mass, relative to the total mass of the coating liquid for the ink receiving layer.

In the invention, in order to prevent curl, it is preferable to include an organic solvent having a high boiling point in the ink receiving layer. For the above organic solvent having a high boiling point, water soluble ones are preferable. As water soluble organic solvents having high boiling point, the following alcohols are cited: ethylene glycol, propylene glycol, diethylene glycol, triethylene glycol, glycerin, diethylene glycol monobutyl ether(DEGMBE), triethylene glycol monobutyl ether, glycerin monomethyl ether, 1,2,3-butane triol, 1,2,4-butane triol, 1,2,4-pentane triol, 1,2,6-hexane triol, thiodiglycol, triethanolamine, polyethylene glycol (average molecular weight of 400 or less). Diethylene glycol monobutyl ether(DEGMBE) is preferable.

The amount of the above organic solvent having a high boiling point used in the coating liquid for the ink receiving layer is preferably 0.05% by mass to 1% by mass, and particularly preferably 0.1% by mass to 0.6% by mass. The ink receiving layer may contain various inorganic salts, in order to enhance dispersibility of fine particles, and acids or alkalis as a pH controlling agent.

Furthermore, in the viewpoints of suppressing frictional electrification and peeling electrification of the surface of the ink receiving layer, metal oxide fine particles having electron conductivity may be contained in the ink receiving layer. And in the viewpoint of reducing a frictional property of the surface, various matting agents may be contained in the ink receiving layer.

The thickness of the ink receiving layer of the invention needs to be determined in connection with the porosity of the layer, because the layer needs to have an absorption capacity allowing adsorption of all droplets in the case of inkjet recording. For example, when the ink amount is 8 nL/mm² and the porosity is 60%, a layer having a thickness of about 15 μm or more is required. Considering this respect, in the case of inkjet recording, the thickness of the ink receiving layer is preferably 10 μm to 50 μm.

The diameter of a pore of the ink receiving layer is preferably 0.005 μm to 0.030 μm and more preferably 0.01 μm to 0.025 μm, in terms of median size. The porosity and the pore median size can be measured using a mercury porosimeter “PORE SIZER 9320-PC2” (trade name) manufactured by Shimadzu Corporation.

In the ink receiving layer in the present invention, it is necessary that the PB ratio of the upper layer is larger by 1 or more than the PB ratio of the lower layer. The adjustment of the PB ratio is performed by suitably adjusting the amounts of inorganic fine particles and water soluble resin which are mainly included in each ink receiving layer. Since there is an indirect correlation of layer thickness, the PB ratio may be adjusted by adjusting the layer thickness.

In order to allow the PB ratio of the upper layer to be larger by 1 or more than the PB ratio of the lower layer, it is preferable to provide each layer so that the thickness of the upper layer is equal to (50%:50%) or smaller (thinner) than that of the lower layer.

The thickness of the ink receiving layer may be controlled by the coating amount of the coating liquid for the ink receiving layer. In order to allow the PB ratio of the upper layer to be larger by 1 or more than the PB ratio of the lower layer, the ratio of dry weight of the upper layer: dry weight of the lower layer is preferably 1:9 to 5:5, and more preferably 2:8 to 4:6 when the total dry weight of the ink receiving layer is 100%. It is preferable to apply the coating liquid for the ink receiving layer so that the ratio of the dry weight of the upper layer to the dry weight of the lower layer is within the above-described range.

The ink receiving layer is preferably higher in transparency, and the haze value, an indicator of transparency, of the ink receiving layer formed on a transparent film support is preferably 30% or less and more preferably 20% or less. The haze value may be determined by using a hazemeter (trade name: HGM-2DP, manufactured by Suga Test Instrument Co., Ltd.).

To the layers (e.g., ink receiving layer) forming the inkjet recording medium of the invention, a polymer fine particle dispersion may be added. The polymer fine particle dispersion is used for the purpose of improving film physical properties, such as dimension stabilization, curl inhibition, adhesion inhibition, or inhibition of film cracking. The polymer fine particle dispersion is described in each of JP-A Nos. 62-245258, 62-1316648, and 62-110066. When a polymer fine particle dispersion having a low glass transition temperature (40° C. or lower) is added to the ink receiving layer, cracking or curling of the layer can be prevented. Even when a polymer fine particle dispersion having a high glass transition temperature is added to a back layer, curling can be prevented.

(Non-Water-Absorptive Support)

As the support used in the invention, non-absorptive support is used. The term “non-absorptive” means absorbing no water and/or no solvent contained in the inkjet recording ink, and especially no water. As the support, any one of a transparent support made of a transparent material such as plastics and a non-transparent support made of a non-transparent material such as paper can be used. However, as the outermost layer on a side of a support where an ink receiving layer is disposed, a resin layer including a thermoplastic resin such as polyethylene (hereinafter, in some cases, simply referred to as a “thermoplastic resin-containing layer”) is preferably disposed. This thermoplastic resin-containing layer can be disposed as needs arise on both sides of paper base materials.

In the next place, the thermoplastic resin will be described.

The thermoplastic resin is not limited to particular one, and one obtained by fine-graining a known thermoplastic resin such as a polyolefin resin (for instance, a homopolymer of a-olefin such as polyethylene or polypropylene, or a mixture of these homopolymers) or a latex thereof can be appropriately selected to use. Among these, as thermoplastic resin, a polyolefin resin is preferable (particularly, polyethylene resin).

The polyolefin resin, as far as it can be extrusion-coated, is not limited on the molecular weight thereof, and the molecular weight can be appropriately selected according to the purpose. Normally, a polyolefin resin having a molecular weight in the range of 20,000 to 200,000 is used.

As for the polyethylene resin, there is no particular limitation. For instance, high-density polyethylene (HDPE), low-density polyethylene (LDPE) and linear low-density polyethylene (L-LDPE) can be cited.

In the thermoplastic resin-containing layer, a white pigment, a colored pigment or a fluorescent whitening agent, or stabilizers such as phenol, bisphenol, thiobisphenol, amines, benzophenone, salicylate, benzotriazole and organometallic compounds can be preferably added.

As a method of forming the thermoplastic resin-containing layer, melt-extrusion, wet-lamination and dry lamination methods can be cited, and the melt-extrusion method is the most preferable one. When a thermoplastic resin-containing layer is formed by means of the melt extrusion, in order to strengthen the adhesion between a thermoplastic resin-containing layer and a lower layer thereof (hereinafter, referred to as a coated layer), a surface of the coated layer is preferably pre-treated.

As the pre-treatment, acid etching with a sulfuric acid-chromic acid mixture, flame processing with a gas flame, a UV-irradiation treatment, a corona discharge treatment, a glow discharge treatment and anchor coating of alkyl titanate can be cited, and an appropriate one can be selected therefrom to use. In particular, from the viewpoint of conveniences, a corona discharge treatment is preferable. When a corona discharge treatment is applied, the pre-treatment is necessarily applied so that a contact angle with water may be 70° or less.

—Paper Base Material—

For the support in the invention, a paper base material that is a non-transparent support can be used.

The paper base material may be a natural pulp paper containing a common natural pulp as a main component; a mixed paper containing a natural pulp and a synthetic fiber; a synthetic fiber paper containing a synthetic fiber as a main component; or a simulated paper, which is produced from a synthetic resin film of such as polystyrene, polyethylene terephthalate or polypropylene. A natural pulp paper (hereinafter, referred to simply as a “base paper”) is particularly preferable. The base paper may be a neutral paper (pH: 5 to 9) or an acidic paper, but is preferably a neutral paper.

As the base paper, one which has as the primary raw material natural pulp selected from conifers and broad leaf trees and to which, as needs arise, a loading material such as clay, talc, calcium carbonate, or urea resin fine particles; a sizing agent such as rosin, an alkyl ketene dimer, a higher fatty acid, epoxidized fatty acid amide, paraffin wax, or alkenyl succinate; a paper strength intensifying agent such as starch, polyamide polyamine epichlorohydrin, or polyacrylamide; and a fixing agent such as aluminum sulfate or a cationic polymer are added can be used. Furthermore, a softening agent such as a surfactant may be added thereto. Still furthermore, synthetic paper that uses synthetic pulp instead of the natural pulp may be used, or a mixture of natural pulp and synthetic pulp in an arbitrary ratio may be used. Among these, broad leaf tree pulp of short fiber and high smoothness is preferably used. The hydrature of pulp material to be used is preferably in the range of 200 mL to 500 mL (C.S.F.), and more preferably in the range of 300 mL to 400 mL.

The paper base material may contain ingredients such as a sizing agent, softening agent, paper strength additive, and fixing agent. The sizing agents include rosins, paraffin waxes, higher fatty acid salts, alkenyl succinate, fatty acid anhydrides, styrene-maleic anhydride copolymers, alkyl ketene dimers and epoxidized fatty acid amides. The softening agents include reaction products from maleic anhydride copolymers and polyalkylene polyamines, and higher fatty acid quaternary ammonium salts. The paper strength additives include polyacrylamide, starch, polyvinyl alcohol, melamine-formaldehyde condensates and gelatin. The fixing agents include aluminum sulfate and polyamide polyamine epichlorohydrins. Additionally, as needs arise, a dye, fluorescent dye or anti-static agent may be added.

The aforementioned paper base material is preferably subjected, prior to the formation of thermoplastic resin-containing layer, to an activation treatment such as a corona discharge treatment, flame treatment, glow discharge treatment or plasma treatment.

—Calender Process—

The support according to the invention can be subjected to a calender treatment.

When after a thermoplastic resin-containing layer is disposed on the paper base material, a calender treatment is applied under specific conditions, the planarity of thermoplastic resin-containing layer can be obtained, and high glossiness, high planarity and high quality image forming property of a surface of an ink receiving layer formed through thermoplastic resin-containing layer can be secured.

The calender treatment is preferably applied in such a manner that, with a soft calender or super calender at least one of a pair of rolls of which is constituted of a metal roll (preferably constituted of a metal roll and a resin roll) or both thereof, a surface temperature of the metal roll is set to a temperature equal to or higher than the glass transition temperature of thermoplastic resin and the nip pressure between a roll nip of the pair of rolls is set to 50 kg/cm to 400 kg/cm.

In what follows, a soft calender and a super calender, both having a metal roll and a resin roll, will be detailed. The metal roll, as long as it is a cylindrical or columnar roll having a smooth surface and has a heating unit inside thereof, is not particularly limited on a material, that is, a known metal roll can be appropriately selected to use. Furthermore, the metal roll is preferably as smooth as possible in the surface roughness since the metal roll comes into contact with a recording surface side of surfaces on both sides of the support in the calender treatment, that is, a surface on a side where the ink receiving layer is formed. The surface roughness is specifically preferably 0.3 s or less in terms of the surface roughness stipulated by JIS B0601, and more preferably 0.2 s or less.

Furthermore, a surface temperature of the metal roll during the treatment is generally preferably in the range of 70° C. to 250° C. when the paper base material is treated. On the other hand, when the paper base material on which thermoplastic resin layer is coated is treated, the surface temperature is preferably equal to or higher than the glass transition temperature Tg of thermoplastic resin contained in the thermoplastic resin-containing layer, and more preferably Tg or higher but Tg+40° C. or lower.

The resin roll may be appropriately selected from a synthetic resin roll made of a polyurethane resin or a polyamide resin, and the shore D hardness is suitably from 60 to 90.

The nip pressure of the pair of rolls having the metal roll is appropriately from 50 kg/cm to 400 kg/cm, and preferably from 100 kg/cm to 300 kg/cm. The treatment is desirably carried out substantially once or twice when a soft calender and/or super calender that is provided with a pair of rolls that are constituted as described above is used.

A support used for an inkjet recording medium of the invention is not particularly limited; that is, a transparent support made of a transparent material such as plastics can be used as well. As a material capable of being used in the transparent support, a material that is transparent and has the nature capable of withstanding radiation heat when used in OHP or backlight display is preferable. As such a material, for instance, polyesters such as polyethylene terephthalate (PET), polysulfone, polyphenylene oxide, polyimide, polycarbonate and polyamide can be cited. Among these, polyesters are preferable; in particular, polyethylene terephthalate is preferable.

Furthermore, with a read only optical disk such as CD-ROM or DVD-ROM, a write once optical disk such as CD-R or DVD-R or a rewritable optical disk as a support, an ink receiving layer and a gloss imparting layer can be imparted as well on a the label surface side.

<<Method for Producing Inkjet Recording Medium>>

The method of producing the inkjet recording medium in the present invention is not particularly limited. For example, the following method of producing the inkjet recording medium of the present invention is listed.

For example, the method of producing the inkjet recording medium includes the step of applying a coating liquid A for the lower layer (hereinafter simply referred to as a “coating liquid A”) of the ink receiving layer containing at least inorganic fine particles and a water soluble resin and a coating liquid B for the upper layer (hereinafter simply referred to as a “coating liquid B”) of the ink receiving layer containing inorganic fine particles and a water soluble resin on the non-water-absorptive support in the order of the coating liquid A for the ink receiving layer and the coating liquid B for the ink receiving layer as viewed from the non-water-absorptive support side.

In addition, the step of applying a coating liquid for forming another structural layer (for example, intermediate layer) may be included.

With reference to inorganic fine particles and a water soluble resin which are included in the coating liquid A and the coating liquid B as well as other components (for example, a crosslinking agent) to be used if necessary, respective components described as the components which can be contained in the above-mentioned ink receiving layer may be used.

In the present invention, it is necessary to suitably adjust the amounts of inorganic fine particles and a water soluble resin in the coating liquid A which is the coating liquid for the lower layer and the amounts of inorganic fine particles and a water soluble resin in the coating liquid B which is the coating liquid for the upper layer so that the ΔPB ratio is 1 or more.

The non-water-absorptive support is similar to the description of the inkjet recording medium.

In the producing method, the method of applying the coating liquids A and B (and other coating liquids to be used as needed) is not particularly limited as long as the coating liquids are applied in the order of the coating liquid A and the coating liquid B as viewed from the non-water-absorptive support side.

For example, a sequential coating method (for example, blade coater, air knife coater, roll coater, bar coater, gravure coater, reverse coater, or the like) in which a layer is coated one by one may be used or a multilayer simultaneous coating method (for example, slide bead coater, slide curtain coater, or the like) may be used. Alternatively, for example, a “Wet-On-Wet method” described in JP-A No. 2005-14593 (paragraphs, 0016 to 0037) may be used.

A method of combining at least two selected from the sequential coating, multilayer coating, and Wet-On-Wet coating may be used.

The dry coating amount of the coating liquid A is preferably 12 g/m² or more, and more preferably 14.5 g/m² or more from the viewpoints of ensuring the rate and capacity of ink absorption.

The dry coating amount of the coating liquid B is preferably 12 g/m² or less, and more preferably in the range of 2 g/m² to 10 g/m².

(Preparation of Coating Liquid)

Subsequently, examples of the preparation method of respective coating liquids for forming the ink receiving layer will be described. However, the present invention is not limited to the following examples.

For example, the coating liquid for forming the ink receiving layer may be prepared in the following manner.

Vapor-phase process silica fine particles and a dispersing agent are added to water (for example, the content of silica particles in water: 10% by mass to 20% by mass), which is dispersed using a high speed rotation wet type colloid mill (for example, trade name: Creamix, manufactured by M Technique Co., Ltd.) under a condition of a high-speed rotating of 10000 rpm (preferably, 5000 rpm to 20000 rpm), for example, for 20 minutes (preferably for 10 minutes to 30 minutes). Thereafter, a polyvinyl alcohol (PVA) aqueous solution (for example, the mass of PVA is set to about one third of the mass of the vapor-phase process silica), if necessary, a crosslinking agent (for example, boric acid) and a cationic emulsion are added thereto, which is dispersed under the same conditions described above.

In the above dispersion process, a liquid-liquid impact type disperser (for example, trade name: Ultimaizer, manufactured by SUGINO MACHINE LIMITED) may be used.

The obtained coating liquid is in a uniform sol state. The coating liquid is applied on the support by the following coating method and dried, so that a porous ink receiving layer having a three-dimensional network structure may be formed.

In the preparation of an aqueous dispersion including the vapor-phase process silica and the dispersing agent, an aqueous dispersion of the vapor-phase process silica is prepared in advance. The aqueous dispersion may be added to the dispersing agent aqueous solution, the dispersing agent aqueous solution may be added to the aqueous dispersion of the vapor-phase process silica or the aqueous dispersion and the aqueous solutions may be mixed at the same time. In place of the aqueous dispersion of the vapor-phase process silica, powder of the vapor-phase process silica may be added to the dispersing agent aqueous solution in the manner as described above.

The above described vapor-phase process silica is mixed with the dispersing agent. Thereafter, the resulting mixture is fine-grained using a disperser, and an aqueous dispersion having an average particle diameter of 50 nm to 300 nm may be obtained. Examples of the disperser to be used to obtain the aqueous dispersion include various types of conventionally known dispersers such as a high-speed rotating disperser, a medium-stirring type disperser (a ball mill, sand mill, or the like.), an ultrasonic disperser, a colloid mill disperser, and a high-pressure disperser. From the viewpoint of efficiently performing dispersion of lumpy fine particles to be formed, a stirring type disperser, a colloid mill disperser, and a high-pressure disperser are preferable.

Examples of a solvent to be used in each step include water, organic solvents, or mixed solvents thereof. Examples of the organic solvent to be used for the coating include alcohols such as methanol, ethanol, n-propanol, i-propanol, and methoxy propanol; ketones such as acetone and methyl ethyl ketone; tetrahydrofuran, acetonitrile, ethyl acetate, toluene and the like.

As the above described dispersing agent, cationic polymers may be used. Examples of the cationic polymer include examples of the mordant which are described in JP-A Nos. 2006-321176 (paragraphs 0138 to 0148). It is also preferable to use a silane coupling agent as the dispersing agent.

The addition amount of the dispersing agent is preferably 0.1% to 30%, and more preferably 1% to 10% with respect to the amount of fine particles.

In the method of producing the inkjet recording medium of the present invention, other steps such as cooling step and/or drying step after applying each coating liquid may be provided.

As an embodiment of the cooling step and the drying step, the following embodiment is listed.

That is, a step of cooling the formed coated film so that the temperature of the film is decreased by 5° C. or more of the temperature of coating liquid at the time of the coating and a step of drying the cooled coated layer to form an ink receiving layer are included.

In the embodiment, a preferable example of the method of cooling the coated layer in the cooling step includes a method of cooling the support on which the coated layer is formed in a cooling zone kept at 0° C. to 10° C. for 5 seconds to 30 seconds. The temperature of the cooling zone is more preferably 0° C. to 5° C.

Here, the temperature of the coated layer is measured by measuring the temperature of the surface of the coated layer.

Further, the ink receiving layer is formed on the non-water-absorptive support, which may be then subjected to the calender process by passing between roller nips under heat and pressure using a super calender, a gloss calender, or the like in order to improve the surface smoothness, glossiness, transparency, and coated film strength.

As for the calender process, the following conditions are preferred from the viewpoint of the porosity.

That is, the roll temperature when the calender process is performed is preferably 30° C. to 150° C., and more preferably 40° C. to 100° C. The linear pressure between rollers in the calender process is preferably 50 kg/cm to 400 kg/cm, and more preferably 100 kg/cm to 200 kg/cm.

<Inkjet Recording Method>

The inkjet recording method of the invention includes recording on an inkjet recording medium of the invention using inkjet ink containing at least a dye, water, and a water soluble organic solvent, wherein 40% by mass or more of the water soluble organic solvent contained in the inkjet ink is at least one member selected from the group consisting of ethylene glycol monoalkyl ether, diethylene glycol monoalkyl ether, propylene glycol monoalkyl ether, dipropylene glycol monoalkyl ether, alkanediol, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

According to the inkjet recording method of the invention, a clear and high density recorded image can be obtained, and the changes in hue from the hue obtained immediately after image printing can be suppressed.

<Inkjet Ink>

The inkjet ink according to the invention contains at least a dye, water, and a water soluble organic solvent, and, as required, may contain other ingredients. The inkjet ink of the invention may be at least one selected from the group consisting of yellow ink, magenta ink, cyan ink, and black ink and may be constituted as an ink set in which these inks are combined. Hereinafter, each ingredient contained in the inkjet ink according to the invention will be described below.

—Water Soluble Organic Solvent—

The inkjet ink according to the present invention contains a water soluble organic solvent. It is necessary in the invention that 40% or more by mass of the water soluble organic solvent included in the inkjet ink comprises at least one water soluble organic solvent (it may refer as a specific water soluble organic solvent in some case) selected from the group consisting of ethylene glycol monoalkyl ether, diethylene glycol monoalkyl ether, propylene glycol monoalkyl ether, dipropylene glycol monoalkyl ether, alkanediol, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

The alkanediol, 1,2-alkanediol having 2 to 6 carbon atoms is preferable, and ethylene glycol or 1,2-propanediol is more preferable from the viewpoint of printed image density.

A carbon number in each alkyl group of ethylene glycol monoalkyl ether, diethylene glycol monoalkyl ether, propylene glycol monoalkyl ether, and dipropylene glycol monoalkyl ether is preferably 1 to 5 respectively, and more preferably 1, 2 or 4.

A carbon number in each alkyl group of ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether is preferably 1 to 3 respectively, and more preferably 1, in order to achieve high printed image density with sufficient solubility in the ink liquid.

Among the above specific water soluble organic solvents, ethylene glycol monomethyl ether, ethylene glycol monoethyl ether, ethylene glycol monobutyl ether, propylene glycol monomethyl ether, propylene glycol monoethyl ether, propylene glycol monobutyl ether, ethylene glycol dimethyl ether, diethylene glycol dimethyl ether, triethylene glycol dimethyl ether, propylene glycol dimethyl ether, dipropylene glycol dimethyl ether, diethylene glycol monomethyl ether (DEGMME), diethylene glycol monoethyl ether (DEGMEE), diethylene glycol monobutyl ether (DEGMBE), triethylene glycol monobutyl ether (TEGMBE), dipropylene glycol monomethyl ether (DPGMME), dipropylene glycol monobutyl ether (DPGMBE), and tripropylene glycol dimethyl ether are particularly preferable.

When the content of the specific water soluble organic solvent is 40% by mass or more with respect to an entire mass of the water soluble organic solvent contained in the inkjet ink, sufficient performance is obtained in terms of printed image density and changes in hue from the hue obtained immediately after image printing.

The content of the specific water soluble organic solvent is more preferably 60% by mass or more, even more preferably 80% by mass or more, and particularly preferably 90% by mass or more with respect to the water soluble organic solvent contained in the inkjet ink. By using the inkjet ink containing the above-mentioned specific amount of the specific water soluble organic solvent, swelling of the binder after the recording (image printing) can be suppressed when an image is recorded on an inkjet recording medium containing the above-described water soluble resin, and an inkjet recorded image whose image density is high and in which the changes in hue from the hue obtained immediately after image printing are suppressed can be obtained.

Examples of water soluble organic solvents usable for the inkjet ink of the invention other than the specific water soluble organic solvent described above include, monovalent alcohols such as methanol, ethanol, propanol, isopropanol, butanol, isobutanol, sec-butanol, t-butanol, pentanol, hexanol, cyclohexanol and benzyl alcohol; polyhydric alcohols such as diethylene glycol, triethylene glycol, polyethylene glycol, 1,3-propanediol, dipropylene glycol, polypropylene glycol, 1,4-butanediol, 2,3-butanediol, 1,3-hexanediol, 1,3-pentanediol, glycerin, hexanetriol and thio diglycol; glycol derivatives such as ethylene glycol diacetate, ethylene glycol monomethyl ether acetate and ethylene glycol monophenyl ether; amines such as ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine and tetramethylpropylenediamine; and other polar solvents such as formamide, N,N-dimethylformamide, N,N-dimethylacetamide, dimethylsulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile and acetone.

Note that, the water soluble organic solvents may be used solely or in a combination of two or more of them.

In the invention, the “water soluble organic solvent” refers to an organic solvent that is not phase separated and is compatible with water when mixed with water.

The content of the water soluble organic solvent in the inkjet ink according to the invention is preferably 5% by mass to 70% by mass, more preferably 10% by mass to 50% by mass, and particularly preferably 20% by mass to 40% by mass.

—Dye—

The inkjet ink according to the invention further contains at least one dye in addition to the water soluble organic solvent. As the dye, general dyes usable for inkjet can be used. For example, in addition to dyes classified into an acid dye, a direct dye, a reactive dye, a vat dye, a sulfur dye, or a food dye in terms of Color Index, dyes classified into an oil-soluble dye, a basic dye, etc., can also be used.

Moreover, examples of the dye of the invention include an azo dye, an azomethine dye, a xanthene dye, and a quinone dye. Specific compounds of the dyes are listed below. However, the dyes used in the invention are not limited to the specific compounds below.

[C.I. Acid Yellow]

C.I. Acid Yellow Nos. 1, 3, 11, 17, 18, 19, 23, 25, 36, 38, 40, 42, 44, 49, 59, 61, 65, 67, 72, 73, 79, 99, 104, 110, 114, 116, 118, 121, 127, 129, 135, 137, 141, 143, 151, 155, 158, 159, 169, 176, 184, 193, 200, 204, 207, 215, 219, 220, 230, 232, 235, 241, 242 and 246.

[C.I. Acid Orange]

C.I. Acid Orange Nos. 3, 7, 8, 10, 19, 24, 51, 56, 67, 74, 80, 86, 87, 88, 89, 94, 95, 107, 108, 116, 122, 127, 140, 142, 144, 149, 152, 156, 162, 166 and 168.

[C.I. Acid Red]

C.I. Acid Red Nos. 1, 6, 8, 9, 13, 18, 27, 35, 37, 52, 54, 57, 73, 88, 97, 106, 111, 114, 118, 119, 127, 131, 138, 143, 145, 151, 183, 195, 198, 211, 215, 217, 225, 226, 249, 251, 254, 256, 257, 260, 261, 265, 266, 274, 276, 277, 289, 296, 315, 318, 336, 337, 357, 359, 361, 362, 364, 366, 399, 407 and 415.

[C.I. Acid Violet]

C.I. Acid Violet Nos. 17, 19, 21, 42, 43, 47, 48, 49, 54, 66, 78, 90, 97, 102, 109 and 126.

[C.I. Acid Blue]

C.I. Acid Blue Nos. 1, 7, 9, 15, 23, 25, 40, 62, 72, 74, 80, 83, 90, 92, 103, 104, 112, 113, 114, 120, 127, 128, 129, 138, 140, 142, 156, 158, 171, 182, 185, 193, 199, 201, 203, 204, 205, 207, 209, 220, 221, 224, 225, 229, 230, 239, 249, 258, 260, 264, 278, 279, 280, 284, 290, 296, 298, 300, 317, 324, 333, 335, 338, 342 and 350.

[C.I. Acid Green]

C.I. Acid Green Nos. 9, 12, 16, 19, 20, 25, 27, 28, 40, 43, 56, 73, 81, 84, 104, 108 and 109.

[C.I. Acid Brown]

C.I. Acid Brown Nos. 2, 4, 13, 14, 19, 28, 44, 123, 224, 226, 227, 248, 282, 283, 289, 294, 297, 289, 301, 355, 357, and 413.

[C.I. Acid Black]

C.I. Acid Black Nos. 1, 2, 3, 24, 26, 31, 50, 52, 58, 60, 63, 107, 109, 112, 119, 132, 140, 155, 172, 187, 188, 194, 207 and 222.

[C.I. Direct Yellow]

C.I. Direct Yellow Nos. 8, 9, 10, 11, 12, 22, 27, 28, 39, 44, 50, 58, 79, 86, 87, 98, 105, 106, 130, 132, 137, 142, 147 and 153.

[C.I. Direct Orange]

C.I. Direct Orange Nos. 6, 26, 27, 34, 39, 40, 46, 102, 105, 107 and 118.

[C.I. Direct Red]

C.I. Direct Red Nos. 2, 4, 9, 23, 24, 31, 54, 62, 69, 79, 80, 81, 83, 84, 89, 95, 212, 224, 225, 226, 227, 239, 242, 243 and 254.

[C.I. Direct Violet]

C.I. Direct Violet Nos. 9, 35, 51, 66, 94 and 95.

[C.I. Direct Blue]

C.I. Direct Blue Nos. 1, 15, 71, 76, 77, 78, 80, 86, 87, 90, 98, 106, 108, 160, 168, 189, 192, 193, 199, 200, 201, 202, 203, 218, 225, 229, 237, 244, 248, 251, 270, 273, 274, 290 and 291.

[C.I. Direct Green]

C.I. Direct Green Nos. 26, 28, 59, 80 and 85.

[C.I. Direct Brown]

C.I. Direct Brown Nos. 44, 106, 115, 195, 209, 210, 222 and 223.

[C.I. Direct Black]

C.I. Direct Black Nos. 17, 19, 22, 32, 51, 62, 108, 112, 113, 117, 118, 132, 146, 154, 159 and 169.

[C.I. Basic Yellow]

C.I. Basic Yellow Nos. 1, 2, 11, 13, 15, 19, 21, 28, 29, 32, 36, 40, 41, 45, 51, 63, 67, 70, 73 and 91.

[C.I. Basic Orange]

C.I. Basic Orange Nos. 2, 21 and 22.

[C.I. Basic Red]

C.I. Basic Red Nos. 1, 2, 12, 13, 14, 15, 18, 23, 24, 27, 29, 35, 36, 39, 46, 51, 52, 69, 70, 73, 82 and 109.

[C.I. Basic Violet]

C.I. Basic Violet Nos. 1, 3, 7, 10, 11, 15, 16, 21, 27 and 39.

[C.I. Basic Blue]

C.I. Basic Blue Nos. 1, 3, 7, 9, 21, 22, 26, 41, 45, 47, 52, 54, 65, 69, 75, 77, 92, 100, 105, 117, 124, 129, 147 and 151.

[C.I. Basic Green]

C.I. Basic Green Nos. 1 and 4.

[C.I. Basic Brown]

C.I. Basic Brown No. 1.

[C.I. Reactive Yellow]

C.I. Reactive Yellow Nos. 2, 3, 7, 15, 17, 18, 22, 23, 24, 25, 27, 37, 39, 42, 57, 69, 76, 81, 84, 85, 86, 87, 92, 95, 102, 105, 111, 125, 135, 136, 137, 142, 143, 145, 151, 160, 161, 165, 167, 168, 175 and 176.

[C.I. Reactive Orange]

C.I. Reactive Orange Nos. 1, 4, 5, 7, 11, 12, 13, 15, 16, 20, 30, 35, 56, 64, 67, 69, 70, 72, 74, 82, 84, 86, 87, 91, 92, 93, 95, and 107.

[C.I. Reactive Red]

C.I. Reactive Red Nos. 2, 3, 5, 8, 11, 21, 22, 23, 24, 28, 29, 31, 33, 35, 43, 45, 49, 55, 56, 58, 65, 66, 78, 83, 84, 106, 111, 112, 113, 114, 116, 120, 123, 124, 128, 130, 136, 141, 147, 158, 159, 171, 174, 180, 183, 184, 187, 190, 193, 194, 195, 198, 218, 220, 222, 223, 228 and 235.

[C.I. Reactive Violet]

C.I. Reactive Violet Nos. 1, 2, 4, 5, 6, 22, 23, 33, 36 and 38.

[C.I. Reactive Blue]

C.I. Reactive Blue Nos. 2, 3, 4, 5, 7, 13, 14, 15, 19, 21, 25, 27, 28, 29, 38, 39, 41, 49, 50, 52, 63, 69, 71, 72, 77, 79, 89, 104, 109, 112, 113, 114, 116, 119, 120, 122, 137, 140, 143, 147, 160, 161, 162, 163, 168, 171, 176, 182, 184, 191, 194, 195, 198, 203, 204, 207, 209, 211, 214, 220, 221, 222, 231, 235 and 236.

[C.I. Reactive Green]

C.I. Reactive Green Nos. 8, 12, 15, 19 and 21.

[C.I. Reactive Brown]

C.I. Reactive Brown Nos. 2, 7, 9, 10, 11, 17, 18, 19, 21, 23, 31, 37, 43 and 46.

[C.I. Reactive Black]

C.I. Reactive Black Nos. 5, 8, 13, 14, 31, 34 and 39.

[C.I. Food Black]

C.I. Food Black Nos. 1 and 2.

As a magenta dye, a cyan dye, a black dye, and a yellow dye usable for the inkjet ink according to the invention, the following dyes are also suitable.

More specifically, examples of the magenta dye usable for the inkjet ink according to the invention include aryl or heterocyclic azo dyes having, for example, phenols, naphthols, or anilines, as a coupler component; azomethine dyes having, for example, pyrazolones or pyrazolotriazoles, as a coupler component; methine dyes, such as an arylidene dye, a styryl dye, a merocyanine dye, a cyanine dye, or an oxonol dye; carbonium dyes, such as a diphenylmethane dye, a triphenylmethane dye, or a xanthene dye; quinone dyes, such as naphthoquinone, anthraquinone, or anthrapyridone; and condensed polycyclic dyes, such as a dioxazine dye, but are not limited thereto.

As the magenta dye, a heterocyclic azo dye is preferable and examples include substances mentioned in International Patent Publication Nos. 2002/83795 (pages. 35 to 55) and 2002-83662 (pages 27 to 42) and JP-A Nos. 2004-149560 (paragraphs [0046] to [0059]), 2004-149561 (paragraphs [0047] to [0060]), and 2007-70573 (paragraphs [0073] to [0082]).

Examples of the cyan dye usable for the inkjet ink according to the invention include aryl or heterocyclic azo dyes having, for example, phenols, naphthols, or anilines, as a coupler component; azomethine dyes having, for example, heterocycles, such as phenols, naphthols, or pyrrolotriazole, as a coupler component; polymethine dyes, such as a cyanine dye, an oxonol dye, or a merocyanine dye; carbonium dyes, such as a diphenylmethane dye, a triphenylmethane dye, or a xanthene dye; a phthalocyanine dye; an anthraquinone dye, and an indigo•thioindigo dye, but are not limited thereto.

An associative phthalocyanine dye is preferable and examples include substances mentioned in International Application Publication Nos. 2002/60994, 2003/811 and 2003/62324 and JP-A Nos. 2003-213167, 2004-75986, 2004-323605, 2004-315758, 2004-315807, 2005-179469, and 2007-70573 (paragraphs [0083] to [0090]).

Examples of the black dye usable for the inkjet ink according to the invention include a disazo dye, a trisazo dye, and a tetrakisazo dye. These black dyes may be used in combination with a pigment, such as a dispersion of carbon black.

Preferable examples of the black dye are mentioned in detail in JP-A Nos. 2005-307177 and 2006-282795 (paragraphs [0068] to [0087]).

Examples of the yellow dye usable for the inkjet ink according to the invention include substances mentioned in International Patent Publication WO 2005/075573, JP-A Nos. 2004-83903 (paragraphs [0024] to [0062]), 2003-277661 (paragraphs [0021] to [0050]), 2003-277262 (paragraphs [0042] to [0047]), 2003-128953 (paragraphs [0025] to [0076]), and 2003-41160 (paragraphs [0028] to [0064]), and U.S. Patent Application Publication No. 2003/0213405 (paragraph [0108]), C.I. Direct Yellow Nos. 8, 9, 11, 12, 27, 28, 29, 33, 35, 39, 41, 44, 50, 53, 59, 68, 86, 87, 93, 95, 96, 98, 100, 106, 108, 109, 110, 130, 132, 142, 144, 161, and 163, C.I. Acid Yellow Nos. 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, and 227, C.I. Reactive Yellow Nos. 2, 3, 13, 14, 15, 17, 18, 23, 24, 25, 26, 27, 29, 35, 37, 41, and 42, and C.I. Basic Yellow Nos. 1, 2, 4, 11, 13, 14, 15, 19, 21, 23, 24, 25, 28, 29, 32, 36, 39, and 40. Moreover, the yellow dyes mentioned in paragraphs [0013] to [0112] and [0114] to [0121] of JP-A No. 2007-191650 are preferable.

As dyes for use in the inkjet ink according to the invention, water soluble dyes are preferable. The types of the water soluble dyes are not limited, and are suitably selected considering color tones or the like required in the inkjet ink. In the invention, the “water soluble dye” refers to dyes that are substantially water soluble, and refers to dyes whose solubility in water at 20° C. is preferably 2% by mass or more and more preferably 5% by mass or more.

When the inkjet ink according to the invention is at least one selected from the group consisting of yellow ink, magenta ink, cyan ink, and black ink, each of the magenta dye and the cyan dye contained in the inkjet ink may be an anionic water soluble dye, the water soluble group of the anionic water soluble dye may be a sulfonic acid group, and an Li⁺ ion or a quaternary ammonium ion may be used as a counter ion.

More specifically, in the invention, the water soluble group of the anionic water soluble dye in the magenta ink and the cyan ink can be specified as a sulfonic acid group and the counter ion thereof can be specified as an Li⁺ ion or a quaternary ammonium ion. The optimal counter ion is an Li⁺ ion.

Similarly, the yellow dyes and the black dyes contained respectively in the yellow inks and the black inks are all anionic water soluble dyes, and the water soluble group of the anionic water soluble dye is a sulfonic acid group, a carboxy group, or a phenolic hydroxy group. It is preferable that, when the water soluble group is a sulfonic acid group, an Li⁺ ion or a quaternary ammonium ion be used as a counter ion and that, when the water soluble group is a carboxy group or a phenolic hydroxy group, a K⁺ ion or an Na⁺ ion be used as a counter ion.

As a preferable combination, when the water soluble group is a sulfonic acid group, the counter ion is a Li⁺ ion. When the water soluble group is a carboxy group or a phenolic hydroxy group, in order to give priority to the solubility of dyes in water, the counter ion is preferably a K⁺ ion and, in order to give priority to the interaction with dyes having a sulfonic acid group, an Na⁺ ion is preferable as a counter ion. They are suitably selected.

Thus, the water soluble group and the counter ion have the optimal combination, and preferable counter ions for a sulfonic acid group and a carboxy group are different from each other. Therefore, it is preferable for the dyes not to simultaneously contain a sulfonic acid group and a carboxy group in the molecules.

The content of the dye contained in the inkjet ink according to the invention is preferably 0.5% by mass to 30% by mass and more preferably 1.0% by mass to 15% by mass. By adjusting the content to 0.5% by mass or more, printing density becomes favorable. By adjusting the content to 30% by mass or lower, an increase in viscosity of the inkjet ink and the generation of structural viscosity in the viscosity characteristics can be suppressed. Thus, favorable discharging stability of the ink from an inkjet head is achieved.

In order to increase the discharging stability, printing quality, image durability, etc., of the inkjet ink for use in the invention, additives, such as surfactants, drying inhibitors, penetration accelerators, urea additives, chelating agents, UV absorbers, antioxidants, viscosity controlling agents, surface tension regulators, dispersing agents, dispersion stabilizers, antiseptic agents, antifungal agents, anticorrosives, pH adjustors, defoaming agents, polymer materials, or acid precursors, mentioned in JP-A No. 2004-331871, etc., can be suitably selected for use. Preferable amounts of the additives are as described in JP-A No. 2004-331871 mentioned above.

Moreover, preferable ranges, measurement methods, adjustment methods, and the like of ink physical properties, such as pH, conductivity, viscosity, static surface tension, or dynamic surface tension of inkjet ink, are as described in JP-A No. 2004-331871.

Methods for preparing the inkjet ink are described in detail in each method of JP-A Nos. 5-148436, 5-295312, 7-97541, 7-82515, 7-118584, and 2004-331871, and also can be used for the preparation of the inkjet ink for use in the invention.

In the production of the inkjet ink, supersonic oscillation can also be added to, for example, a process for melting additives, such as dyes, as described in JP-A No. 2004-331871.

When the inkjet ink is produced, a process of removing wastes, which are solid, by filtration performed after liquid preparation is important. The filtering process is as described in JP-A No. 2004-331871.

—Inkjet Recording Method—

In the inkjet recording method of the invention, an inkjet recording system is not limited, and known systems, such as an electric charge control system including discharging (ejecting) ink utilizing an electrostatic attraction force, a drop on demand system (pressure pulse system) utilizing vibration pressure of a piezo-electric element, an acoustic inkjet system including changing an electrical signal into an acoustic beam, irradiating ink with the acoustic beam, and discharging the ink utilizing radiation pressure, or a thermal inkjet system including heating ink to form bubbles, and utilizing the generated pressure, is used. The inkjet recording system includes a system of ejecting a large number of inks having a low concentration, referred to as photo ink, with a small volume, a system of improving image quality using a plurality of inks having substantially the same hue and different concentrations, or a system using colorless transparent ink.

(Drying Process)

In the inkjet recording method of the invention, it is preferable to perform drying after image printing (preferably within 10 minutes after image printing). A drying device is provided in an inkjet recording apparatus in an in-line or off-line manner. As a heating method, general methods, such as warm air or hot air heating using a hot air ventilation dryer, infrared drying using an infrared lamp, hot roll heating, or induction heating, are performed. In order to obtain a recorded image excellent in density and suppressing changes in hue from the hue obtained immediately after image printing without causing a problem of, for example, curling due to overheating, the drying treatment is preferably performed within 1 minute after image printing and the drying is preferably performed at 50° C. to 200° C. for 1 second to 5 minutes.

### Examples

In what follows, the invention will be detailed with reference to examples. However, the invention is not restricted to the examples. In the examples, word “parts” and symbol “%”, respectively, mean “parts by mass” and “% by mass”.

First, the inkjet recording medium of the present invention will be described based on Examples 1 to 6 and Comparative examples 1 to 4. Next, the inkjet recording method of the present invention will be described based on Examples 1, 7 to 27 and Comparative examples 5 to 11.

### Example 1

### <Production of Non-Water-Absorptive Support>

50 parts of LBKP formed of acacia and 50 parts of LBKP formed of aspen were individually refined to 300 mL of Canadian freeness using a disc refiner, thereby preparing pulp slurry.

To the pulp slurry obtained above, 1.3% of cation modified starch (CAT0304L; trade name, manufactured by Nippon NSC Ltd.), 0.15% of anionic polyacrylamide (POLYACRON ST-13; trade name, manufactured by Seiko Chemicals, Co., Ltd.), 0.29% of alkyl ketene dimer (SIZE PINE K; trade name, manufactured by Arakawa Chemical Industries, Ltd.), 0.29% of epoxidized behenic acid amide, and 0.32% of polyamide polyamine epichlorohydrin (ARAFIX 100; trade name, manufactured by Arakawa Chemical Industries, Ltd.), with respect to pulp, were added, and then 0.12% of defoaming agent was added.

In a process of forming the pulp slurry prepared as described above into paper using a Fortlinear paper machine, pressing a felt side of a web against a drum dryer cylinder through a dryer canvas, and drying, the drying was performed while the tensile strength of the dryer canvas was adjusted to 1.6 kg/cm, then 1 g/m² of polyvinyl alcohol (KL-118; trade name, manufactured by Kuraray) was applied on both sides of a base paper using a size press and dried, and then calender treatment was performed. Paper making was performed at a basis weight of the base paper of 166 g/m² to obtain a 160 μm-thick base paper.

Corona discharge treatment was performed to the wire surface side of the obtained base paper, and then high density polyethylene was coated using a molten extruder so that the thickness was 25 μm, thereby forming a thermoplastic resin layer with a mat surface (hereinafter, the thermoplastic resin layer side being referred to as the “rear surface”). Corona discharge treatment was further performed to the thermoplastic resin layer on the rear surface side, and then a dispersion liquid, in which aluminum oxide (ALUMINASIL 100; trade name, manufactured by Nissan Chemical Industries, Ltd.) and silicon dioxide (“SNOWTEX O”; trade name, manufactured by Nissan Chemical Industries, Ltd.), as antistatic agents, were dispersed in water at a mass ratio of 1:2 was applied so that the dry mass was 0.2 g/m².

Furthermore, corona discharge treatment was performed to the felt surface side of the base paper on which the thermoplastic resin layer was not provided. Thereafter, low density polyethylene having a MFR (melt flow rate) of 3.8 was prepared so that the content of anatase titanium dioxide was 10%, the content of ultramarine blue manufactured by Tokyo Ink Co., Ltd. was 0.3% and the content of “WHITEFLOUR PSN CONC” (trade name) as a fluorescent whitening agent manufactured by Nippon Chemical Industrial Co., LTD. was 0.08%. The obtained low density polyethylene was extruded using a molten extruder so that the thickness was 25 μm, thereby forming a thermoplastic resin layer having high glossiness on the felt surface side of the base paper (hereinafter, the surface on which the thermoplastic resin layer having high glossiness was formed being referred to as the “front surface”).

### <Preparation of Coating Liquid A1 for Lower Layer of Ink Receiving Layers>

(1) AEROSIL300SV (trade name, inorganic fine particles), (2) ion exchanged water, and (3) SHALLOL DC-902P (trade name, dispersing agent), and (4) ZA-30 (trade name) shown in the following composition A1 were mixed, the mixture was dispersed using an ultrasonic disperser [manufactured by SMT Co., Ltd.] to prepare a dispersion liquid, and then the dispersion liquid was heated to 45° C. and held for 20 hours.

Then, the following components: (5) boric acid, (6) polyvinyl alcohol solution P, and (7) EMULGEN 109P (trade name, surfactant) were added to the dispersion liquid under a condition of 30° C., and thereby, a coating liquid A1 for the lower layer of the ink receiving layers (hereinafter simply referred to as a coating liquid A1) was prepared. The PB ratio of the coating liquid A1 was 4.2.

—Composition A1 of Coating Liquid A1—

| | | |
|---|---|---|
| (1) AEROSIL300SV | 100 | parts by mass |
| [trade name; manufactured by Nippon Aerosil | | |
| Inc., vapor-phase process silica fine particles | | |
| (inorganic fine particles)] | | |
| (2) Ion exchanged water | 545.9 | parts by mass |
| (3) SHALLOL DC-902P | 8.7 | parts by mass |
| (51.5% aqueous solution) [trade name; | | |
| manufactured by DAIICHI KOGYO SEIYAKU | | |
| CO., LTD., dispersing agent] | | |
| (4) ZA-30 | 5.4 | parts by mass |
| [trade name; manufactured by, Daiichi Kigenso | | |
| Kagaku Kogyo Co., Ltd., zirconyl acetate, 50% | | |
| aqueous solution] | | |
| (5) Boric acid (7.5% aqueous solution) | 49 | parts by mass |
| [crosslinking agent] | | |
| (6) Polyvinyl alcohol solution P having the | 340.1 | parts by mass |
| following composition P [water soluble resin] | | |
| (7) EMULGEN 109P [trade name; | 0.6 | parts by mass |
| manufactured by Kao Corporation, surfactant] | | |

—Composition P of Polyvinyl Alcohol Solution P—

| | |
|---|---|
| JM33 [trade name; manufactured by JAPAN VAM & | 7 parts by mass |
| POVAL CO., LTD., polyvinyl alcohol, saponification | |
| degree: 95%, polymerization degree: 3300] | |
| Ion exchanged water | 93 parts by mass |

<Preparation of Coating Liquid B1 for Upper Layer of Ink Receiving Layers>

A coating liquid B1 for the upper layer of the ink receiving layers (hereinafter simply referred to as a coating liquid B1) was prepared in a manner substantially similar to that in the preparation of the coating liquid A1, except that the amount of the polyvinyl alcohol solution P was changed to 230.4 parts by mass in the preparation of the coating liquid A1. The PB ratio of the coating liquid B1 was 8.2.

—Preparation of Inkjet Recording Medium 1—

The front surface of the non-water-absorptive support was subjected to corona discharge treatment. Thereafter, the coating liquids A1 and B1 were simultaneously multilayer-coated in order of the coating liquid A1 and the coating liquid B1 using a slide bead coater. Here, the coating liquid A1 was applied so that the dry weight was 80% of the total dry weight of the ink receiving layer. Further, the coating liquid B1 was applied so that the dry weight was 20% of the total dry weight of the ink receiving layer. The total dry weight of the ink receiving layer was 22 g/m².

Subsequently, the coated film obtained by the simultaneously multilayer-coating was cooled at 10° C. for 20 seconds, followed by drying by spraying hot air (30° C. to 55° C.) and an ink receiving layer was formed on the non-water-absorptive support.

Thus, an inkjet recording medium 1 having two ink receiving layers on the non-water-absorptive support was obtained.

<Preparation of Ink>

Deionized water was added to the components with the following composition C1 so as to be 1 L, which was then stirred for 1 hour while heating at 30° C. to 40° C. Thereafter, the resulting solution was adjusted to have the pH of 9 using KOH (10 mol/L) and subjected to filtration under reduced pressure using a micro-filter using an average pore diameter of 0.25 μm, and thereby, magenta ink liquid (M-101) was prepared.

### —Composition C1—

| | | |
|---|---|---|
| Dye M-1 (shown below) | 35.0 | g/L |
| Glycerol | 98.0 | g/L |
| Triethylene glycol | 23.0 | g/L |
| Triethylene glycol monobutyl ether (TEGMBE) | 116.0 | g/L |
| Propylene glycol | 3.5 | g/L |
| 2-Pyrrolidone | 11.0 | g/L |
| Urea | 24.0 | g/L |
| PROXEL XL2 [trade name; manufactured by AVECIA] | 1.1 | g/L |
| Betaine compound C (shown below) | 17.0 | g/L |

Dye M-1

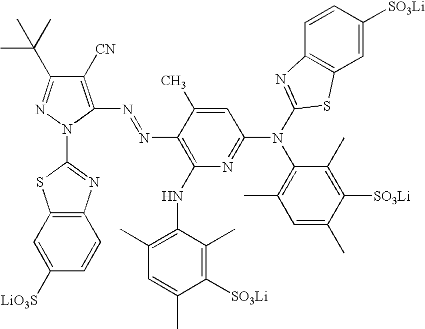

Betaine compound C

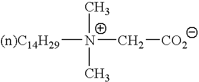

### <Image Recording and Performance Evaluation>

### (Image Recording)

A magenta solid image was printed using the magenta ink (M-101) obtained above onto the side, on which the ink receiving layer was formed, of the inkjet recording medium 1 obtained above using a printer A700 manufactured by Seiko Epson under an environment of 25° C. and 50% RH, while setting the color adjustment to no color correction, and then stored for 24 hours under the same environment.

(Glossiness)

The glossiness of the inkjet recording medium 1 (unprinted) was measured at an incidence angle of 60 degree and a light receiving angle of 60 degree using a digital variable angle glossimeter (UGV-5D, manufactured by Suga Test Instruments Co., Ltd., measured pore: 8 mm). Results were evaluated in accordance with the following evaluation criteria. The obtained results are shown in Table 1.

—Evaluation Criteria—

A . . . The glossiness is 35% or more.

B . . . The glossiness is 30% or more but less than 35%.

C . . . The glossiness is 25% or more but less than 30%.

D . . . The glossiness is less than 25%.

(Color Density)

After the storage, density measurement was performed using X-rite310 (trade name, manufactured by X-rite) and the density was evaluated in accordance with the following evaluation criteria. The obtained results are shown in Table 1.

—Evaluation Criteria—

A . . . The density is 2.4 or more.

B . . . The density is 2.3 or more but less than 2.4.

C . . . The density is 2.2 or more but less than 2.3.

D . . . The density is less than 2.2.

### Example 2

An inkjet recording medium 2 was produced in a manner substantially similar to that in the preparation of the inkjet recording medium 1 above, except that the coating liquids A1 and B1 were applied so that the dry weight ratio was equal to the weight ratio shown in Table 1 below in Example 1. The total dry weight of the ink receiving layers was 22 g/m².

Images were recorded using the obtained inkjet recording medium 2 in a manner substantially similar to that in Example 1, followed by evaluation in a manner substantially similar to that in Example 1. Evaluation results are shown in Table 1 below.

### Examples 3 and 4

A coating liquid A2 for the lower layer of the ink receiving layers was prepared in a manner substantially similar to that in the preparation of the coating liquid A1 above, except that the amount of the polyvinyl alcohol solution P was changed to 366.3 parts by mass in the preparation of the coating liquid A1.

Further, a coating liquid B2 for the upper layer of the ink receiving layers was prepared in a manner substantially similar to the above-described method except that the amount of the polyvinyl alcohol solution P was changed to 116.1 parts by mass in the preparation of the coating liquid B1. The PB ratios of the coating liquids A2 and B2 were 3.9 and 12.3, respectively.

Inkjet recording media 3 and 4 were produced in a manner substantially similar to that in Example 1, except that the coating liquids A2 and B2 were applied in place of the coating liquids A1 and B1 so that the dry weight ratio was equal to the weight ratio shown in Table 1. The total dry weight of the ink receiving layers as to the inkjet recording media 3 and 4 was 22 g/m². Images were recorded using the obtained inkjet recording media 3 and 4 in a manner substantially similar to that in Example 1, followed by evaluation in a manner substantially similar to that in Example 1. Evaluation results are shown in Table 1.

### Examples 5 and 6

A coating liquid A3 for the lower layer of the ink receiving layers was prepared in a manner substantially similar to that in the preparation of the coating liquid A1 above, except that the amount of the polyvinyl alcohol solution P was changed to 317.5 parts by mass in the preparation of the coating liquid A1.

Further, a coating liquid B3 for the upper layer of the ink receiving layers was prepared in a manner substantially similar to the preparation of the coating liquid B1, except that the amount of the polyvinyl alcohol solution P was changed to 230.4 parts by mass in the preparation of the coating liquid B1.

The PB ratios of the coating liquids A3 and B3 were 4.5 and 6.2, respectively.

Inkjet recording media 5 and 6 were produced in a manner substantially similar to that in Example 1, except that the coating liquids A3 and B3 were applied in place of the coating liquids A1 and B1 that the dry weight ratio was equal to the weight ratio shown in Table 1 below.

The total dry weight of the ink receiving layers as to the inkjet recording media 5 and 6 was 22 g/m².

Images were recorded using the obtained inkjet recording media 5 and 6 in a manner substantially similar to that in Example 1, followed by evaluation in a manner substantially similar to that in Example 1. Evaluation results are shown in Table 1.

### Comparative Examples 1 to 3

Coating liquids A4 to A6 for the lower layer of the ink receiving layers were prepared in a manner substantially similar to that in the preparation of the coating liquid A1, except that the addition amount of the polyvinyl alcohol solution P was changed to the following amount in the preparation of the coating liquid A1.

—Addition Amount of Polyvinyl Alcohol Solution P—

Comparative example 1; 317.5 parts by mass

Comparative example 2; 348.4 parts by mass

Comparative example 3; 204.1 parts by mass

The PB ratios of the coating liquids A4, A5, and A6 were 4.5, 4.1, and 7.0, respectively.

Inkjet recording media 7 to 9 were produced in a manner substantially similar to that in Example 1, except that in Example 1, the coating liquids A4 to A6 was respectively applied in place of the coating liquid A1 and the coating liquid B1 was not applied. The total dry weight of the ink receiving layer as to the inkjet recording media 7 to 9 was 22 g/m².

Images were recorded using the obtained inkjet recording media 7 to 9 in a manner substantially similar to that in Example 1, followed by evaluation in a manner substantially similar to that in Example 1. Evaluation results are shown in Table 1 below.

### Comparative Example 4

A coating liquid A7 for the lower layer of the ink receiving layers was prepared in a manner substantially similar to that in the preparation of the coating liquid A1, except that the amount of the polyvinyl alcohol solution P was changed to 304 parts by mass in the preparation of the coating liquid A1.

Further, a coating liquid B4 for the upper layer of the ink receiving layers was prepared in a manner substantially similar to that in the preparation of the coating liquid B1 except that the amount of the polyvinyl alcohol solution P was changed to 259.7 parts by mass in the preparation of the coating liquid B1.

The PB ratios of the coating liquids A7 and B4 were 4.7 and 5.5, respectively.

An inkjet recording medium 10 was produced in a manner substantially similar to that in Example 1, except that the coating liquids A7 and B4 were applied in place of the coating liquids A1 and B1 so that the dry weight ratio was equal to the weight ratio shown in Table 1. The total dry weight of the ink receiving layers was 22 g/m².

Images were recorded using the obtained inkjet recording medium 10 in a manner substantially similar to that in Example 1, followed by evaluation in a manner substantially similar to that in Example 1. Evaluation results are shown in the following Table 1.

TABLE 1

| | | Ink receiving layer | | | | | | |
|---|---|---|---|---|---|---|---|---|
| | Inkjet | Upper | | Lower | | | Evaluation | |
| | re- | layer | | layer | | | results | |
| | cording | | Ratio | | Ratio | | Glossi- | Color |
| | medium | PB | (%) | PB | (%) | ΔPB | ness | density |
| Example 1 | 1 | 8.2 | 20 | 4.2 | 80 | 4 | A | A |
| Example 2 | 2 | 8.2 | 30 | 4.2 | 70 | 4 | B | A |
| Example 3 | 3 | 12.3 | 10 | 3.9 | 90 | 8.4 | A | A |
| Example 4 | 4 | 12.3 | 20 | 3.9 | 80 | 8.4 | B | A |
| Example 5 | 5 | 6.2 | 30 | 4.5 | 70 | 1.7 | A | B |
| Example 6 | 6 | 6.2 | 50 | 4.5 | 50 | 1.7 | A | B |
| Compara- | 7 | — | — | 4.5 | 100 | — | A | C |
| tive | | | | | | | | |
| Example 1 | | | | | | | | |
| Compara- | 8 | — | — | 4.1 | 100 | — | A | C |
| tive- | | | | | | | | |
| Example 2 | | | | | | | | |
| Compara- | 9 | — | — | 7.0 | 100 | — | C | B |
| tive | | | | | | | | |
| Example 3 | | | | | | | | |
| Compara- | 10 | 5.5 | 30 | 4.7 | 70 | 0.8 | A | C |
| tive | | | | | | | | |
| Example 4 | | | | | | | | |

In Table 1, the “PB” in the column of the ink receiving layer indicates the PB ratio of the upper layer or lower layer of the ink receiving layers. The “ratio” indicates the ratio of the dry weight of each layer with respect to the total dry weight of the ink receiving layers. Further, the “ΔPB” indicates a numerical value obtained by subtracting the PB ratio of the lower layer from the PB ratio of the upper layer of the ink receiving layers.

Subsequently, the inkjet recording method of the present invention will be described based on Examples 7 to 27 and Comparative examples 5 to 11.

### Example 7

Magenta ink (M-102) was prepared in a manner substantially similar to that in Example 1, except that the following composition C2 was used in place of the composition C1 in the preparation of the magenta ink (M-101). Then, images were recorded using the magenta ink (M-102) and the inkjet recording medium 1 in a manner substantially similar to that in Example 1. The inkjet recording medium after the image recording was subjected to the following evaluation and was designated as Example 7.

### —Composition C2—

| | | |
|---|---|---|
| Dye M-1 (shown above) | 35.0 | g/L |
| Glycerol | 102.0 | g/L |
| Triethylene glycol | 19.0 | g/L |
| Ethylene glycol monomethyl ether (EGMME) | 100.0 | g/L |
| 2-Pyrrolidone | 11.0 | g/L |
| Urea | 24.0 | g/L |
| PROXEL XL2 [trade name; manufactured by AVECIA] | 1.1 | g/L |
| Betaine compound C (shown above) | 17.0 | g/L |

(Color Density)

Color density was evaluated in a manner substantially similar to that in Example 1 in accordance with the same evaluation criteria in Example 1. The obtained results are shown in Table 2 described below.

(Changes in Hue from Hue Obtained Immediately After Image Printing)

A magenta solid image was printed by discharging the magenta ink onto the side, on which the ink receiving layer was formed, of the inkjet recording medium 1 obtained above using a printer A700 manufactured by Seiko Epson under an environment of 23° C. and 50% RH.

Immediately after printing (within 2 minutes after printing) and after 24 hours had passed after printing, the hue of the magenta solid portion was measured, and a difference between the hue immediately after printing and the hue after 24 hours had passed after printing was defined as a hue difference (ΔE).

Here, the hue was determined by determining L*a*b* under the conditions of a light source F8 and a viewing angle of 2° using a spectrophotometer (trade name: SPECTROLINO, manufactured by GretagMacbeth AG.).

Based on the obtained hue difference (ΔE), changes in discoloration were evaluated according to the following evaluation criteria. The obtained results are shown in Table 2 described below.

### —Evaluation Criteria—

A: ΔE<1; Changes in hue are hardly recognized.

B: 1≦ΔE<2; Changes in hue are recognized but are not noticeable.

C: 2≦ΔE<4; Changes in hue are considerably noticeable.

D: 4≦ΔE; Changes in hue are noticeable, causing problems.

### Examples 8 to 20, Comparative Examples 8 and 9

Magenta ink was prepared in a manner substantially similar to that in the preparation of the magenta ink (M-102) except that EGMME in the magenta ink liquid (M-102) was replaced with the ink solvent shown in Table 2 below. Images were recorded in a manner substantially similar to that in Example 7 except that the obtained magenta ink liquid was used in place of the magenta ink (M-102) in Example 7. The inkjet recording media after the image recording were evaluated and designated as Examples 8 to 20 and Comparative examples 8 and 9. The obtained results are shown in Table 2 below.

Changes in the hue as to the image recording in Example 1 were also evaluated. The evaluation results are shown in Table 2 described below.

### Examples 21 to 27

A magenta ink was prepared in a manner substantially similar to that in Example 1 except triethylene glycol monobutyl ether (TEGMBE) of the composition C1 was replaced by a water soluble organic solvent shown in Table 2 described below in the preparation of the magenta ink (M-101). Then, inkjet recording (image printing) was performed using the inkjet recording medium 1. Image printing was performed in a manner substantially similar to that in Example 1, except that the inkjet recording medium after 5 seconds from the image printing was subjected to drying (drying process) at 80° C. for one minute using a hot air dryer (TSK-60; trade name, manufactured by TAKETSUNA MANUFACTORY CO., LTD.), and then evaluation was performed in a manner substantially similar to that in Example 1. The obtained results are shown in Table 2 described below.

### Comparative Example 5

A magenta ink (M-103) was prepared in a manner substantially similar to that in the preparation of the magenta ink (M-102) in Example 7 except that the composition C2 was changed to the following composition C3 in the preparation of the magenta ink (M-102).

### —Composition C3—

| | | |
|---|---|---|
| Dye M-1 (mentioned above) | 35.0 | g/L |
| Glycerol | 123.0 | g/L |
| Triethylene glycol | 23.0 | g/L |
| Ethylene glycol monomethyl ether (EGMME) | 70.0 | g/L |
| 2-Pyrrolidone | 14.0 | g/L |
| Urea | 24.0 | g/L |
| PROXEL XL2 [trade name; manufactured by AVECIA] | 1.1 | g/L |
| Betaine compound C (mentioned above) | 17.0 | g/L |

An image was printed on the inkjet recording medium 1 in a manner substantially similar to that in Example 1 except that the magenta ink (M-103) was used in replace of the magenta ink (M-102), and evaluation was performed in a manner substantially similar to that in Example 1. The obtained results are shown in Table 2 described below.

### Comparative Example 6

A magenta ink was prepared in a manner substantially similar to that in Comparative Example 5, except that ethylene glycol monomethyl ether (EGMME) of the composition C3 was replaced by a water soluble organic solvent shown in Table 2 described below in the preparation of the magenta ink (M-103). Then, inkjet recording (image printing) was performed using the inkjet recording medium 1, and evaluation was performed in a manner substantially similar to that in Example 1. The obtained results are shown in Table 2 described below.

### Comparative Example 7

A magenta ink (M-104) was prepared in a manner substantially similar to that in the preparation of the magenta ink (M-102) except that the composition C2 was changed to the following composition C4 in the preparation of the magenta ink (M-102).

### Composition C4—

| | | |
|---|---|---|
| Dye M-1 (mentioned above) | 35.0 | g/L |
| Glycerol | 114.0 | g/L |
| Triethylene glycol | 22.0 | g/L |
| Ethylene glycol monomethyl ether (EGMME) | 81.0 | g/L |
| 2-Pyrrolidone | 13.0 | g/L |
| Urea | 24.0 | g/L |
| PROXEL XL2 [trade name; manufactured by AVECIA] | 1.1 | g/L |
| Betaine compound C (mentioned above) | 17.0 | g/L |

Printing was performed on the inkjet recording medium 1 in a manner substantially similar to that in Example 7 except that the magenta ink (M-104) was used in place of the magenta ink (M-102), and evaluation was performed in a manner substantially similar to that in Example 7. The obtained results are shown in Table 2 below.

### Comparative Examples 10 and 11

Printing was performed in a manner substantially similar to that in Examples 1 and 7 except that the inkjet recording medium 7 produced in Comparative Example 1 was used in place of the inkjet recording medium 1 in Examples 1 and 7 and then evaluation was performed in a manner substantially similar to that in Examples 1 and 7. The obtained results are shown in the following Table 2.

TABLE 2

| | | | Ink receiving layer | | | | | Evaluation | |
|---|---|---|---|---|---|---|---|---|---|
| | Ink | | Upper | | Lower | | | results | |
| | Solvent | | layer | | layer | | | Color | Changes |
| | Type | Ratio (%) | PB | Ratio (%) | PB | Ratio (%) | Drying step | density | in hue |
| Example 1 | TEGMBE | 43 | 8.2 | 20 | 4.2 | 80 | Not included | A | B |
| Example 7 | DEGMME | 43 | 8.2 | 20 | 4.2 | 80 | Not included | A | B |
| Example 8 | DEGMBE | 43 | 8.2 | 20 | 4.2 | 80 | Not included | A | B |
| Example 9 | DEGMEE | 43 | 8.2 | 20 | 4.2 | 80 | Not included | A | B |
| Example 10 | PGMME | 43 | 8.2 | 20 | 4.2 | 80 | Not included | A | B |
| Example 11 | DPGMME | 43 | 8.2 | 20 | 4.2 | 80 | Not included | A | B |
| Example 12 | DPGMBE | 43 | 8.2 | 20 | 4.2 | 80 | Not included | A | B |
| Example 13 | DEGDME | 43 | 8.2 | 20 | 4.2 | 80 | Not included | A | B |
| Example 14 | EGDME | 43 | 8.2 | 20 | 4.2 | 80 | Not included | A | B |
| Example 15 | 1,2-hexanediol | 43 | 8.2 | 20 | 4.2 | 80 | Not included | A | B |
| Example 16 | 1,2-pentanediol | 43 | 8.2 | 20 | 4.2 | 80 | Not included | A | B |
| Example 17 | 1,2-butanediol | 43 | 8.2 | 20 | 4.2 | 80 | Not included | A | B |
| Example 18 | 1,2-propanediol | 43 | 8.2 | 20 | 4.2 | 80 | Not included | A | B |
| Example 19 | ethylene glycol | 43 | 8.2 | 20 | 4.2 | 80 | Not included | A | B |
| Example 20 | 2-methylpentane-2,4-diol | 43 | 8.2 | 20 | 4.2 | 80 | Not included | A | B |
| Example 21 | EGMME | 43 | 8.2 | 20 | 4.2 | 80 | Included | A | A |
| Example 22 | DEGMME | 43 | 8.2 | 20 | 4.2 | 80 | Included | A | A |
| Example 23 | DEGMBE | 43 | 8.2 | 20 | 4.2 | 80 | Included | A | A |
| Example 24 | 1,2-hexanediol | 43 | 8.2 | 20 | 4.2 | 80 | Included | A | A |
| Example 25 | 1,2-pentanediol | 43 | 8.2 | 20 | 4.2 | 80 | Included | A | A |
| Example 26 | 1,2-butanediol | 43 | 8.2 | 20 | 4.2 | 80 | Included | A | A |
| Example 27 | 1,2-propanediol | 43 | 8.2 | 20 | 4.2 | 80 | Included | A | A |
| Comparative Example 5 | EGMME | 30 | 8.2 | 20 | 4.2 | 80 | Not included | B | C |
| Comparative Example 6 | DEGMME | 30 | 8.2 | 20 | 4.2 | 80 | Not included | B | C |
| Comparative Example 7 | EGMME | 35 | 8.2 | 20 | 4.2 | 80 | Not included | A | C |
| Comparative Example 8 | TEGMME | 43 | 8.2 | 20 | 4.2 | 80 | Not included | B | C |
| Comparative Example 9 | TetraEGMME | 43 | 8.2 | 20 | 4.2 | 80 | Not included | B | C |
| Comparative Example 10 | TEGMBE | 43 | — | — | 4.5 | 100 | Not included | C | C |
| Comparative Example 11 | DEGMME | 43 | — | — | 4.5 | 100 | Not included | C | C |

Abbreviates in the columns of the water soluble organic solvent in the Table 2 denote as follows;
TEGMBE: triethylene glycol monobutyl ether
DEGMME: diethylene glycol monomethyl ether
DEGMBE: diethylene glycol monobutyl ether
DEGMEE: diethylene glycol monoethyl ether
PGMME: propylene glycol monomethyl ether
DPGMME: dipropylene glycol monomethyl ether
DPGMBE: dipropylene glycol monobutyl ether
DEGDME: diethylene glycol dimethyl ether
EGDME: ethylene glycol dimethyl ether
TEGMME: triethylene glycol monomethyl ether
TetraEGMME: tetraethylene glycol monomethyl ether

In Table 2, the “PB” in the column of the ink receiving layer indicates the PB ratio in the upper layer and the lower layer of the ink receiving layers. The “ratio” indicates the ratio of the dry weight of each layer with respect to the total dry weight of the ink receiving layers.

As is apparent from the results in Table 1, the inkjet recording medium in which the PB ratio of the upper layer was larger by 1 or more than the PB ratio of the lower layer was excellent in both glossiness and color density. In the case of the inkjet recording medium having a monolayer ink receiving layer (Comparative examples 1 to 3) and the inkjet recording medium with ΔPB ratio of less than 1, either or both of glossiness or color density were not satisfied.

As is apparent from the results in Table 2, the inkjet recording medium (Examples 1 and 7 to 27) in which inkjet recording (printing) was performed with the inkjet ink using a certain water soluble organic solvent and having ΔPB ratio of 1 or more showed a high ink density and little discoloration. The inkjet recording medium (Examples 21 to 27) in which the drying step was added in the step of inkjet recording had smaller changes in the hue than those of the inkjet recording medium (Examples 1, 7 to 20) in which the drying step was not included.

The present invention may namely provide the following items <1> to <10>:

<1> An inkjet recording medium including: at least two ink receiving layers which contain inorganic fine particles and a water soluble resin on a non-water-absorptive support, wherein a mass ratio of the inorganic fine particles to the water soluble resin in an upper layer of the ink receiving layers which is the furthest away from the non-water-absorptive support is larger by 1 or more than a mass ratio of the inorganic fine particles to the water soluble resin in a lower layer of the ink receiving layers which is located between the upper layer and the non-water-absorptive support.

<2> The inkjet recording medium according to item <1>, wherein the inorganic fine particles are vapor-phase process silica.

<3> The inkjet recording medium according to item <1> or item <2>, wherein the water soluble resin is a polyvinyl alcohol.

<4> The inkjet recording medium according to any one of items <1> to <3>, wherein the content of the water soluble resin is 9% by mass to 40% by mass with respect to the total solid mass of the ink receiving layer.

<5> The inkjet recording medium according to any one of items <1> to <4>, wherein an average primary particle diameter of the inorganic fine particles is 20 nm or less, and an average secondary particle diameter of the inorganic fine particles is 200 nm or less.

<6> The inkjet recording medium according to any one of items <1> to <5>, wherein the mass ratio of the inorganic fine particles to the water soluble resin in the upper layer of the ink receiving layers is from 3 to 25, and the mass ratio of the inorganic fine particles to the water soluble resin in the lower layer is from 1.5 to 6.

<7> The inkjet recording medium according to any one of items <1> to <6>, wherein the ink receiving layers further include a boron compound and a zirconyl compound.

<8> An inkjet recording method including performing recording on the inkjet recording medium according to any one of items <1> to <7> by using an inkjet ink comprising at least a dye, water and a water soluble organic solvent, wherein 40% by mass or more of the water soluble organic solvent is at least one selected from the group consisting of ethylene glycol monoalkyl ether, diethylene glycol monoalkyl ether, propylene glycol monoalkyl ether, dipropylene glycol monoalkyl ether, alkanediol, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

<9> The inkjet recording method according to item <8>, further comprising drying the inkjet recording medium after the recording.

<10> The inkjet recording method according to item <9>, wherein the drying is performed at 50° C. to 200° C. for 1 second to 5 minutes.

The foregoing description of the exemplary embodiments of the present invention has been provided for the purposes of illustration and description. It is not intended to be exhaustive or to limit the invention to the precise forms disclosed. The embodiments were chosen and described in order to best explain the principles of the invention and its practical applications, thereby enabling others skilled in the art to understand the invention for various embodiments and with the various modifications as are suited to the particular use contemplated.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. An inkjet recording medium comprising:
at least two ink receiving layers which comprise inorganic fine particles and a water soluble resin on a non-water-absorptive support, wherein
a mass ratio of the inorganic fine particles to the water soluble resin in an upper layer of the ink receiving layers which is the furthest away from the non-water-absorptive support is larger by 1 or more than a mass ratio of the inorganic fine particles to the water soluble resin in a lower layer of the ink receiving layers which is located between the upper layer and the non-water-absorptive support.

2. The inkjet recording medium according to claim 1, wherein the inorganic fine particles are vapor-phase process silica.

3. The inkjet recording medium according to claim 1, wherein the water soluble resin is a polyvinyl alcohol.

4. The inkjet recording medium according to claim 1, wherein the content of the water soluble resin is 9% by mass to 40% by mass with respect to the total solid mass of the ink receiving layer.

5. The inkjet recording medium according to claim 1, wherein an average primary particle diameter of the inorganic fine particles is 20 nm or less, and an average secondary particle diameter of the inorganic fine particles is 200 nm or less.

6. The inkjet recording medium according to claim 1, wherein the mass ratio of the inorganic fine particles to the water soluble resin in the upper layer of the ink receiving layers is from 3 to 25, and the mass ratio of the inorganic fine particles to the water soluble resin in the lower layer is from 1.5 to 6.

7. The inkjet recording medium according to claim 1, wherein the ink receiving layers further comprise a boron compound and a zirconyl compound.

8. An inkjet recording method comprising performing recording on the inkjet recording medium according to claim 1 by using an inkjet ink comprising at least a dye, water and a water soluble organic solvent, wherein 40% by mass or more of the water soluble organic solvent is at least one selected from the group consisting of ethylene glycol monoalkyl ether, diethylene glycol monoalkyl ether, propylene glycol monoalkyl ether, dipropylene glycol monoalkyl ether, alkanediol, ethylene glycol dialkyl ether, diethylene glycol dialkyl ether, triethylene glycol dialkyl ether, propylene glycol dialkyl ether, dipropylene glycol dialkyl ether, and tripropylene glycol dialkyl ether.

9. The inkjet recording method according to claim 8, further comprising drying the inkjet recording medium after the recording.

10. The inkjet recording method according to claim 9, wherein the drying is performed at 50° C. to 200° C. for 1 second to 5 minutes.
